(19) United States
(12) Patent Application Publication
(10) Pub. No.: US 2009/0288106 A1
(43) Pub. Date: Nov. 19, 2009

(54) DISC DRIVE APPARATUS

(76) Inventors: Hiroyuki YOKOE, Ehime (JP); Takeshi Oosora, Ehime (JP); Hiroto Kawata, Ehime (JP)

Correspondence Address: WENDEROTH, LIND & PONACK L.L.P., 1030 15th Street, N.W., Suite 400 East, Washington, DC, 20005-1503, US

(21) Appl. No.: 12/413,843

(22) Filed: Mar. 30, 2009

(30) Foreign Application Priority Data
May 19, 2008 (JP) 2008-131397

(51) Int. Cl. G11B 17/04

(52) U.S. Cl. 720/622; G9B/17.013

(57) ABSTRACT

In an optical disc drive apparatus 10, a main arm 400 is spread by an inserted optical disc 102 as the optical disc 102 is being inserted. A main arm boss 402 slides in a predetermined direction along a disc holder control groove 225 and a main arm boss 403 slides in a predetermined direction along a disc holder rotation groove 222.

### CROSS-REFERENCE TO RELATED APPLICATIONS

This application claims priority to Japan Patent Application No. 2008-131397. The entire disclosures of Japan Patent Application No. 2008-131397 is hereby incorporated herein by reference.

### BACKGROUND OF THE INVENTION

1. Field of the Invention

The present invention relates to a disc drive apparatus of a slot-in type to which disc type recording media, including read-only discs such as CDs, DVDs and the like and discs for recording/reproduction such as CD-Rs, DVD-Rs and the like, can be loaded.

2. Description of the Related Art

Conventionally, disc drive apparatus to/from which disc type recording media such as optical discs can be loaded/ejected in a slot-in method have been used.

For example, Japanese Laid-open Patent Publication No. 2006-331487 discloses a disc drive apparatus which includes a slider for sliding an optical disc inserted from a disc insertion slot in a direction substantially orthogonal to a direction of insertion, disc loading means (for example, six rollers), pinions, and a drive motor for driving these parts so as to rotate in two directions in order to draw the optical disc to a position above a turntable with the optical disc being slid in a surface direction. The disc drive apparatus further includes a main slide cam which is slid in a direction substantially orthogonal to the sliding direction of the slider, a sub-slide cam, first and second biasing means, racks, cam grooves, and cam driven pins.

### SUMMARY OF THE INVENTION

However, the above conventional disc drive apparatus has the following problems.

In the disc drive apparatus disclosed in Japanese Laid-open Patent Publication No. 2006-331487, an optical disc is held at an outer peripheral portion using a plurality of rollers or the like having a drum-like shape and is drawn along a horizontal direction. Then, the rollers are moved away from the disc outer peripheral portion to move the optical disc downward, and the optical disc is chucked to the turntable. In such a structure, many number of parts including rollers are required in order to secure a long ejecting stroke for the optical disc. The disc drive apparatus already includes members such as a slider, a main slide cum, a sub slide cum, and first and second biasing means. Since the number of the parts further increases, it becomes difficult to make the apparatus smaller and thinner.

An object of the present invention is to simplify a structure for loading a disc along a surface direction to a turntable in a disc drive apparatus in order to achieve a small and thin apparatus.

A disc drive apparatus according to the first invention includes a frame portion, an abutting portion, a turntable, and a single arm member. The frame portion has an insertion opening to which a disc of a circular shape is to be inserted. The abutting portion is located near one end in a longitudinal direction of the insertion opening and abuts an end of the disc inserted from the insertion opening. The turntable holds the disc in a rotatable manner. The single arm member guides the disc to a position above the turntable or from the turntable in an ejecting direction while it pinches the disc with the abutting portion and moves along an outer periphery of the disc.

In this apparatus, a single arm member which draws the disc into the apparatus or ejects the disc outside the apparatus while it pinches the disc with the abutting portion and moves along the outer periphery of the disc is provided in a disc loading mechanism for drawing a disc of a circular shape which is inserted from the insertion opening into the disc drive apparatus and guiding to a position above the turntable.

The single arm member may be, for example, a member having a shape substantially like a fan which includes an arc portion along the outer periphery of the disc. The abutting portion may be fixed inside a portion around an end in the longitudinal direction of the insertion opening, and abuts to an end, which is opposite to the side abutting the arm member of the inserted disc (a non-recording portion).

With such a structure, even it is a simple structure employing a single arm member, the disc can be readily drawn to the predetermined position above the turntable by moving the arm member along the outer periphery of the disc in accordance with the position of the disc to be inserted from the insertion opening. As a result, the disc loading mechanism can be simplified, and the disc drive apparatus can be made smaller and thinner.

A disc drive apparatus according to the second invention is the disc drive apparatus according to the first invention, further includes a first biasing member which applies a biasing force for pulling one end on the insertion opening side of the arm member.

In this apparatus, a first biasing member for applying a biasing force which draws one end on the insertion opening side of the single arm member toward the inside of the apparatus.

The first biasing member may be a general spring or the like.

With such a structure, by pulling one end of the single arm member with a spring or the like, the disc can be drawn with the magnitude of the biasing force, which is applied to the disc, being changed in accordance with the insertion position of the disc. As a result, the disc loading mechanism can be formed of a simple structure without using a complicated mechanism such as motor or the like.

A disc drive apparatus according the third invention is the disc drive apparatus of the first or second invention, further includes a disc holder which moves in an insertion direction of the disc as the disc is inserted or ejected and which includes a first groove formed from near the insertion opening along the insertion direction and a second groove formed in a substantially vertical direction with respect to the insertion direction. The arm member includes a plurality of boss portions which move within the first and second grooves while they remain fitted into the first and second grooves.

In this apparatus, for a mechanism which rotates the single arm member along the outer periphery of the disc, grooves formed on the disc holder which moves in the insertion direction of the disc (the first and second grooves) and the boss portions of the arm member which fit therein are combined.

With such a structure, the single arm member can perform a predetermined operation while the disc holder being moved in the disc insertion direction in accordance with the disc insertion position. As a result, even with a simple structure, the arm member can perform a predetermined operation via the disc holder, and the disc can be loaded as well.

A disc drive apparatus according to the fourth invention is the disc drive apparatus according to the third invention, further includes a holder portion, which includes a pair of side surface portions along a direction substantially perpendicular to the surface of the disc on right and left sides and a pair of third grooves, which are formed on the pair of the side surface portions on the right and left sides and have step portions in the substantially vertical direction, and which slides in the disc insertion direction. The disc holder includes ribs which protrude along a direction orthogonal to the insertion direction in the surface direction of the disc and which move along the third grooves while they remain fitted into the third grooves.

In this apparatus, the disc is moved until its center hole comes to a clamp position above the turntable by using the above-described arm member, and then the holder portion is moved forward and backward along the direction the disc is carried. At the same time, the ribs protruded from the side surface portions of the disc holder are moved within the third grooves.

With such a structure, by moving the holder portion including a pair of side surface portions on the right and left sides with the third grooves formed thereon forward and backward in the insertion direction, the disc holder holding the disc can be moved upward and downward in a direction substantially vertical to the disc surface. As a result, the disc moved to the position above the clamp position can be moved upward and downward within the disc holder so as to readily shift to the clamped state or release the clamped state.

A disc drive apparatus according to the fifth invention is the disc drive apparatus according to the third or fourth invention, further including a lock mechanism which retains the position of the disc holder so as to be flush with the insertion opening until the disc is shifted to the clamped state where it is set on the turntable.

In this apparatus, the disc holder which holds the disc inserted from the insertion opening and moves to the position above the clamp position is retained by the lock mechanism so as to be flush with the insertion opening from the time the disc is inserted until it is shifted to the clamped state.

The lock mechanism may be, for example, a member such as lock lever which fits to the side surface of the disc holder and controls the movement in a direction substantially vertical to the disc surface.

With such a structure, the disc holder can be fixed by the lock mechanism such that the disc holder does not move downward when the disc is inserted. As a result, it is ensured that the disc is inserted to a position above the turntable where it can be clamped.

A disc drive apparatus according to the sixth invention is the disc drive apparatus according to any one of the first through fifth inventions further including a retraction mechanism which retracts the arm member outside in a radial direction of the disc once the disc is shifted to the clamped state.

In this apparatus, when the disc is shifted to the clamped state, the single arm member is retracted outside in the radial direction by the retraction mechanism.

With such a structure, the disc can be released from the arm member, and it is shifted to the rotatable state at the clamped position, thereby enabling reading and writing of information.

A disc drive apparatus according to the seventh invention is the disc drive apparatus according to any one of the first through sixth inventions further including an ejecting mechanism which drives the arm member such that the disc moves from the position on the turntable to the position where a diameter portion of the disc passes between an end on the insertion opening side of the arm member and the abutting portion.

In this apparatus, for ejecting the disc from the clamped state, the disc is moved in the surface direction by the ejecting mechanism to a position where the disc can be ejected by using the single arm member (a position where a diameter portion of the disc passes between an end on the insertion opening side of the arm member and the abutting portion).

With such a structure, the disc is moved by the ejecting mechanism to a position where it can be ejected by the arm member, and thus, it is ensured that the disc is ejected from the position of clamped state to a position where the center hole of the disc can be seen even with a simple structure.

A disc drive apparatus according to the eighth invention is the disc drive apparatus according to any one of the first through seventh inventions further including a braking portion which applies a braking force for controlling movement in the surface direction of the disc to the disc when the disc is being inserted/ejected.

In this apparatus, a braking portion which applies a braking force for braking the movement in the surface direction to the disc inserted/ejected from the insertion opening.

The braking portion may be, for example, a mechanism which abuts the disc surface by using a biasing force of a spring or the like and brakes the movement in the surface direction of the disc.

With such a structure, the disc carried out from the insertion opening can be effectively prevented from jumping-out by the above-described arm member and the ejecting mechanism or the like.

A disc drive apparatus according to the ninth invention is the disc drive apparatus according to the eighth invention, the braking portion abuts only to an outer peripheral edge of the disc and applies a braking force to the disc.

In this apparatus, the braking portion abuts only to an outer peripheral edge of the disc, which corresponds to the non-recording portion of the disc, and applies a braking force.

With such a structure, the movement in the surface direction of the disc can be braked in a safe state without damaging the recording portion of the disc by contact with the braking portion.

A disc drive apparatus according to the tenth invention is the disc drive apparatus according to the eighth or ninth invention, the braking portion alters a magnitude of the braking force by moving the position where it abuts the disc as the disc is being inserted/ejected.

In this apparatus, the magnitude of the braking force applied by the braking portion to the disc is altered by moving the position where the braking portion abuts the disc.

The abutting position of the braking portion and the disc can be moved by, for example, rotating the braking portion as the disc moves.

The magnitude of the braking force applied to the disc can varied by the position by changing the area, material, surface finishing of the abutting portion of the braking portion to the disc. For example, the area of the abutting portion which corresponds to the best position of the disc where it is desired to apply the braking force to the disc may be increased, or the material may be changed to the one having a large friction resistance to readily apply a braking force of a desired magnitude at a certain position of the disc.

A disc drive apparatus according to the eleventh invention is the disc drive apparatus according to any one of the eighth through tenth inventions, the braking portion includes a second biasing member which rotates while abutting a part of the disc and applies a biasing force in the rotational direction.

In this apparatus, the braking force applied from the braking portion to the disc is applied by the second biasing member which has a biasing force in the direction to rotate the braking portion.

With such a structure, when the disc is moved in the surface direction, the braking portion having the biasing force in the rotational direction is rotated to apply the braking force to the disc. As a result, the movement in the surface direction of the disc can be braked and the disc can be prevented from jumping out from the insertion opening with a simple structure.

A disc drive apparatus according to the twelfth invention is the disc drive apparatus according to the tenth invention, the braking portion alters an area of an abutting portion, where it abuts the part of the disc, in accordance with the position of the disc.

In this apparatus, the abutting area of the abutting portion of the braking portion to the disc is altered in accordance with, for example, the position of the disc being ejected.

The structure of altering the abutting area may be, for example, a structure in which the abutting surface of the braking portion located diagonally to the disc surface is formed so as to have a triangular shape.

With such a structure, a braking force of a desired magnitude can be applied to the disc by the position of disc by altering the abutting area of the braking portion to the disc in accordance with the position of the disc.

A disc drive apparatus according to the thirteenth invention is the disc drive apparatus according to the tenth invention, the braking portion includes a plurality of areas which have different friction resistances in the abutting portion with the disc.

In this apparatus, areas having a plurality of materials having different friction resistances in the abutting portion of the braking portion to the disc.

The areas having the different friction resistances may be achieved by using rubber materials for portions which are needed to have a larger friction resistance and using felt or the like for portions which are needed to have a smaller friction resistance.

With such a structure, a braking force of a desired magnitude can be applied to the disc by the position of disc by altering the friction resistance of the portion of the braking portion abutting the disc in accordance with the position of the disc.

A disc drive apparatus according to the fourteenth invention is the disc drive apparatus according to the tenth invention, the braking portion includes an area treated with different surface finishing in the abutting portion with the disc.

In this apparatus, areas treated with different surface finishing are provided in the portion of the braking portion abutting the disc.

The different surface finishing may be fine groove processing or the like for the portions which are needed to have a larger friction resistance, and may be Teflon (Trademark) finishing or the like for the portions which are needed to have a smaller friction resistance.

With such a structure, a braking force of a desired magnitude can be applied to the disc by the position of disc by altering the surface finishing for the portion of the braking portion abutting the disc in accordance with the position of the disc.

A disc drive apparatus according to the fifteenth invention is the disc drive apparatus according to the seventh invention, the ejecting mechanism includes a driving portion and a gear for transmitting a driving force from the driving portion. The apparatus further includes an overload control mechanism which prevents damage to the ejecting mechanism and the disc when a load of a predetermined torque or greater is applied to the gear.

In this apparatus, the overload control mechanism for preventing damage to the gear included in the ejecting mechanism and/or the disc even when the user pushes the disc in the insertion direction while the disc is being moved by the ejecting mechanism in the ejecting process for the disc is provided.

The overload control mechanism may be a clutch mechanism incorporated into the gear portion or the like.

With such a structure, damage to the ejecting mechanism and/or the disc can be prevented even when a large load which is not intended is applied to the disc being ejected by the ejecting mechanism.

A disc drive apparatus according to the sixteenth invention is the disc drive apparatus according to the fifteenth invention, the overload control mechanism includes an elastic portion and an engagement portion. The elastic portion controls a load to be applied to the gear. The engagement portion engages one end of the elastic portion and releases engagement with the elastic portion when a load of predetermined magnitude or greater is applied to the gear.

In this apparatus, one end of the elastic portion for controlling the load to be applied to the gear included in the ejecting mechanism is engaged at the engagement portion, and the engagement at the engagement portion is released when a load of a predetermined magnitude or greater is applied to the gear.

With such a structure, when a large load is applied to the gear included in the ejecting mechanism when the disc is being ejected, the overload is not transmitted to the gear since the engagement at the engagement portion to which one end of the elastic portion is engaged is released. As a result, damage to the ejecting mechanism and/or the disc can be readily prevented.

A disc drive apparatus according to the seventeenth invention is the disc drive apparatus according to the sixteenth invention, the overload control mechanism has only one end of the elastic portion being fixed and releases engagement between the elastic portion and the engagement portion by loads of different magnitudes in accordance with a direction of rotation of the gear.

In this apparatus, only one end of the elastic portion is fixed and the other end is remained to be free in the overload control mechanism, and disengagement between the elastic portion and the engagement portion included in the overload control mechanism is performed using loads having different magnitudes in accordance with the rotational direction.

For example, the disengagement may not be performed when the gear rotates in the clockwise direction, and may be performed by a predetermined load when the gear rotates in the counterclockwise direction. As a result, a mechanism in which engagement can be readily released only with a desired rotational direction can be formed.

A disc drive apparatus according to the eighteenth invention is the disc drive apparatus according to the sixteenth or seventeenth invention, the overload control mechanism has the engagement portion of different shapes in the rotational direction of the gear and releases engagement between the elastic portion and the engagement portion by loads of different magnitudes in accordance with the direction of rotation of the gear.

In this apparatus, the shape of the engagement portion to which one end of the elastic portion engage is modified such that it is different in the rotational direction of the gear.

Thus, the disengagement may not be performed when the gear rotates in the clockwise direction, and may be performed by a predetermined load when the gear rotates in the counterclockwise direction. As a result, a mechanism in which engagement can be readily released only with a desired rotational direction can be formed.

A disc drive apparatus according to the nineteenth invention is the disc drive apparatus according to any one of the first through eighteenth inventions, further including a third biasing member which applies a first biasing force and a second biasing force to the arm member. The first biasing force biases a first end on the insertion opening side of the arm member in a direction orthogonal to the disc insertion direction on the disc surface. The second biasing force biases a second end opposite to the first end of the arm member in a direction of ejecting the disc.

In this apparatus, the third biasing member for applying biasing forces to the arm member in two directions toward the initial position before the inserting the disc is used.

The third biasing member may be a helical spring having one and the other abutting ends or the like.

With such a structure, the arm member can be returned to the initial position before the disc insertion by the biasing forces in two directions from the third biasing member, for example, even when the user draws the disc being inserted from the insertion opening during the disc insertion process. As a result, the arm member can be returned to the disc insertion position by a simple structure without providing disc drawing detection means and/or arm member initialization means and the like.

A disc drive apparatus according to the twentieth invention is the disc drive apparatus according to the nineteenth invention, the third biasing member applies the second biasing force which is greater than the first biasing force to the arm member.

In this apparatus, among the biasing forces in two directions as mentioned above, the second biasing force is greater than the first biasing force and is applied to the arm member.

With such a structure, it becomes possible to avoid the situation in which the optical disc cannot be drawn into the disc drive apparatus after the maximum diameter of the optical disc passes by the boss portion.

### BRIEF DESCRIPTION OF THE DRAWINGS

FIG. 1 is a perspective view of an assembled optical disc drive apparatus according to an embodiment of the present invention.

FIG. 2 is an exploded perspective view of the optical disc drive apparatus of FIG. 1.

FIGS. 3A and 3B are exploded perspective views of a holder portion of the optical disc drive apparatus of FIG. 1.

FIG. 4 is a plan view showing a back of the holder portion of the optical disc drive apparatus of FIG. 1.

FIG. 5 is a plan view showing POS 0 state of the optical disc drive apparatus of FIG. 1.

FIG. 6 is a plan view showing POS 1 state of the optical disc drive apparatus of FIG. 1.

FIG. 7 is a plan view showing POS 2 state of the optical disc drive apparatus of FIG. 1.

FIG. 8 is a plan view showing POS 3 state of the optical disc drive apparatus of FIG. 1.

FIG. 9 is a plan view showing POS 4 state of the optical disc drive apparatus of FIG. 1.

FIG. 10 is a plan view showing POS 5 state of the optical disc drive apparatus of FIG. 1.

FIG. 11 is a plan view showing POS 6 state of the optical disc drive apparatus of FIG. 1.

FIG. 12 is a plan view showing POS 7 state of the optical disc drive apparatus of FIG. 1.

FIG. 13 is a plan view showing POS 8 state of the optical disc drive apparatus of FIG. 1.

FIG. 14 is a plan view showing POS 9 state of the optical disc drive apparatus of FIG. 1.

FIGS. 15A through 15D are cross sectional views illustrating a state of SW detection of the optical disc drive apparatus of FIG. 1.

FIG. 16 is a perspective view showing a structure of a drive system of the optical disc drive apparatus of FIG. 1.

FIG. 17 is an exploded perspective view of an unloading gear U of the optical disc drive apparatus of FIG. 1.

FIGS. 18A through 18F are cross sectional views along line Z-Z of FIG. 1.

FIGS. 19A through 19D are perspective views showing a structure of a main arm releasing mechanism of the optical disc drive apparatus of FIG. 1.

FIGS. 20A through 20C are perspective views showing a structure of a sub arm releasing mechanism of the optical disc drive apparatus of FIG. 1.

FIGS. 21A and 21B are perspective views showing a structure of a holder lock mechanism of the optical disc drive apparatus of FIG. 1.

FIGS. 22A and 22B are perspective views showing a structure of a disc jumping out prevention mechanism of the optical disc drive apparatus of FIG. 1.

FIGS. 23A through 23C are cross sectional views showing the structure of the disc jumping out prevention mechanism of the optical disc drive apparatus of FIG. 1.

FIGS. 24A through 24F are plan views showing a structure of a disc unloading mechanism of the optical disc drive apparatus of FIG. 1.

FIGS. 25A through 25D are schematic views for illustrating operations of the disc jumping out prevention mechanism of the optical disc drive apparatus of FIG. 1.

FIGS. 26A through 26C are plan views for illustrating operations of a push arm of the optical disc drive apparatus of FIG. 1.

FIG. 27 is a plan view for a disc drawing-out prevention mechanism of the optical disc drive apparatus of FIG. 1.

FIG. 28 is a plan view showing a state before disc insertion of the optical disc drive apparatus of FIG. 1 which addresses a problem of drawing out the disc.

FIG. 29 is a plan view showing a state during disc insertion of the optical disc drive apparatus of FIG. 1 which addresses a problem of drawing out the disc.

### DETAILED DESCRIPTION OF THE PREFERRED EMBODIMENTS

An optical disc drive apparatus (disc drive apparatus) 10 according to an embodiment of the present invention is described as follows with reference to the drawings.

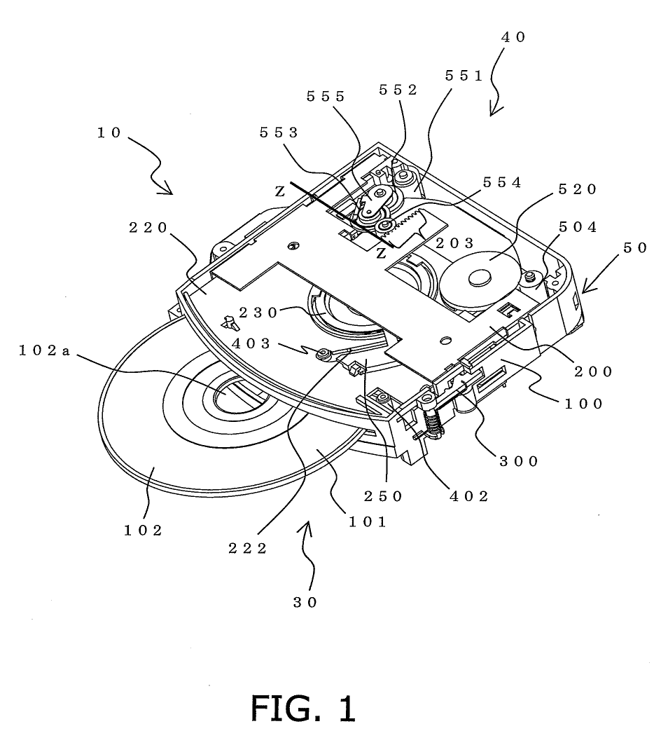

“Horizontal” and “vertical” directions as described in the following description refer to “horizontal” and “vertical” directions when the optical disc drive apparatus 10 is placed as shown in FIG. 1 and the like. Therefore, when the optical disc drive apparatus 10 is placed vertically, the horizontal direction refers to the actual “vertical” direction and the vertical direction refers to the actual “horizontal” direction. Furthermore, “right and left” directions as described in the following description refer to right and left when the apparatus is placed with the disc insertion direction being the front side.

The maximum diameter position of an optical disc 102 refers to a diameter portion of the optical disc 102, which is parallel to a straight line between the right end and the left end of the disc insertion opening 101 when the optical disc 102 is being inserted into the optical disc drive apparatus 10.

### [Structure of Optical Disc Drive Apparatus 10]

The optical disc drive apparatus 10 according to the present embodiment includes a loading mechanism 20, a disc clamp mechanism 30, a disc clamp releasing mechanism 40, an unloading mechanism (ejecting mechanism) 50, a disc jumping out prevention mechanism (braking portion) 60, an overload control mechanism 70, and a disc drawing out prevention mechanism 80.

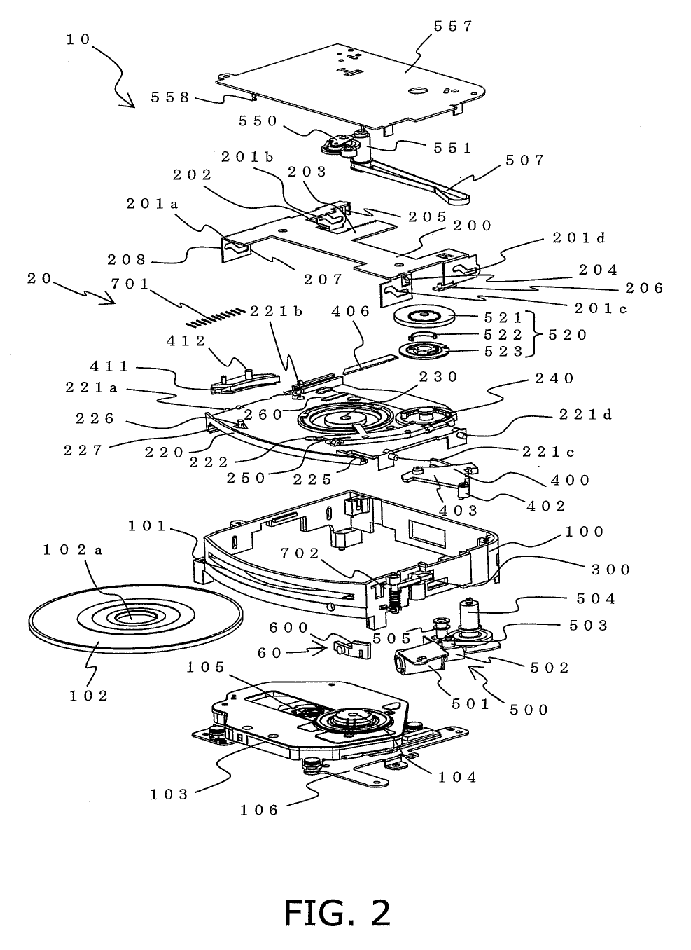

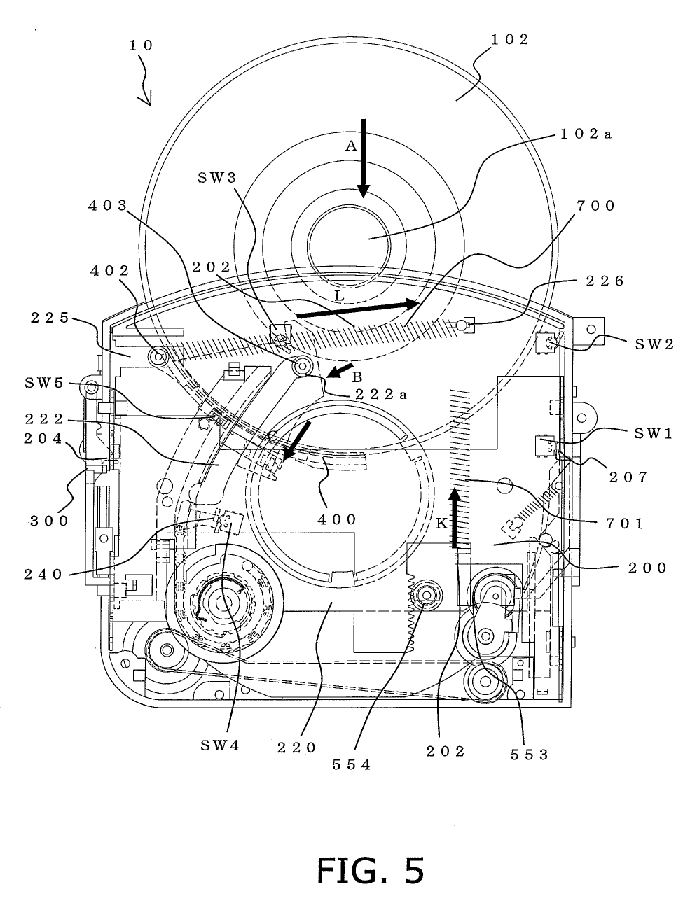

The loading mechanism 20 is a mechanism for loading/ejecting an optical disc 102, which is a recording and reproducing disc such as DVD-R or the like, with the slot-in method, and has a simple structure which includes four switches SW1 through SW4 and one motor (drive portion) 501 (loading motor (see FIG. 2 and so on)). For ejecting the optical disc 102, the loading mechanism 20 can carry the optical disc 102 to a position where its center hole 102a is exposed outside from a disc insertion opening 101 (see FIG. 5) to secure a sufficiently long ejecting stroke. The structure of the loading mechanism 20 will be later described in more detail.

The disc clamp mechanism 30 is a mechanism which moves the optical disc 102 which has been carried to a predetermined position in a direction perpendicular to the disc surface and clamps the disc on a turntable 104. The structure of the disc clamp mechanism 30 will be later described in more detail.

The disc clamp releasing mechanism 40 is a mechanism for releasing the clamped optical disc 102, which is clamped to the turntable 104. The structure of the disc clamp releasing mechanism 40 will be later described in more detail.

The unloading mechanism 50 is a mechanism for performing an eject operation of the optical disc 102, which is clamped to the turntable 104, until it reaches a position where its center hole 102a is ejected from the disc insertion opening 101. The structure of the unloading mechanism 50 will be later described in more detail.

The disc jumping-out prevention mechanism 60 is a mechanism for preventing the optical disc 102 from jumping out by a biasing force of a main arm (arm member) 400 while the optical disc 102 is being ejected from the disc insertion opening 101. The structure of the disc jumping-out prevention mechanism 60 will be later described in more detail.

The overload control mechanism 70 is a mechanism for preventing the disc unloading mechanism 50 from being damaged due to an overload caused by pushing the optical disc 102 in the disc insertion direction while the optical disc 102 is being ejected from the disc insertion opening 101. The structure of the overload control mechanism 70 will be later described in more detail.

The disc drawing-out prevention mechanism 80 is a mechanism for preventing the main arm 400 from being maintained at the position of the disc inserted state even though the optical disc 102 is not inserted in the case where the optical disc 102 is inserted from the disc insertion opening 101 and is drawn out during the loading operation. The structure of the disc drawing-out prevention mechanism 80 will be later described in more detail.

As shown in FIGS. 1 and 2, an external frame (frame portion) 100 of the optical disc drive apparatus 10 is formed such that an outer periphery of a drive fixing frame 106 made of metal is covered with a frame made of a synthetic resin. The external frame 100 has the disc insertion opening 101 and has a substantially rectangular shape. The optical disc drive apparatus 10 has a thin structure having a thickness (height) of 10.8 mm. The maximum width W is 94.5 mm, and the maximum length D is 85.5 mm.

As shown in FIG. 2, the disc insertion opening 101 has a width suitable for a diameter of the optical disc 102. Below the disc insertion opening 101, a disc braking lever 600 is provided. The disc braking lever 600 applies an appropriate load to a lower surface of the outer periphery of the optical disc 102 (non-recording portion) by a disc biasing SP (second biasing member) 704.

To the central further side of the disc insertion opening 101 of the external frame 100 as shown in FIG. 2, a spindle motor (not shown) is attached upward along the substantially horizontal direction. The spindle motor is placed to a substantially central portion of the disc insertion side of an optical pickup unit base (not shown) to which an optical pickup 105 is placed. The optical pickup unit base (not shown) is placed at the lowest position of the drive fixing frame 106 with a plurality of insulators (not shown) being interposed therebetween and along the substantially horizontal direction. On the outer periphery of the spindle motor which is placed upward, the turntable 104 is adhered along the substantially horizontal direction. At the central portion of the turntable 104, a boss for centering having a circular truncated cone shape is integrally formed.

On the further upper side of the spindle motor above the optical pickup unit base, the optical pickup 105 including an objective lens which is pick up means for recording and reproducing video and other information on a recording surface which is a lower surface of the optical disc is provided. The objective lens is incorporated in a central portion inside a thread placed along substantially horizontal direction in an opening formed on the side further than the optical pickup 105 and the like so as to face upward along the substantially vertical direction. The thread is guided by a guide main axis (not shown) and guide sub-axis (not shown) which are provided above the optical pickup unit base and along the substantially horizontal direction which is parallel to both sides of the opening. The thread is formed so as to be seek passed in the radial direction of the optical disc 102 by a lead screw (not shown) which is controlled to rotate by a thread motor (not shown).

### [Loading Mechanism 20]

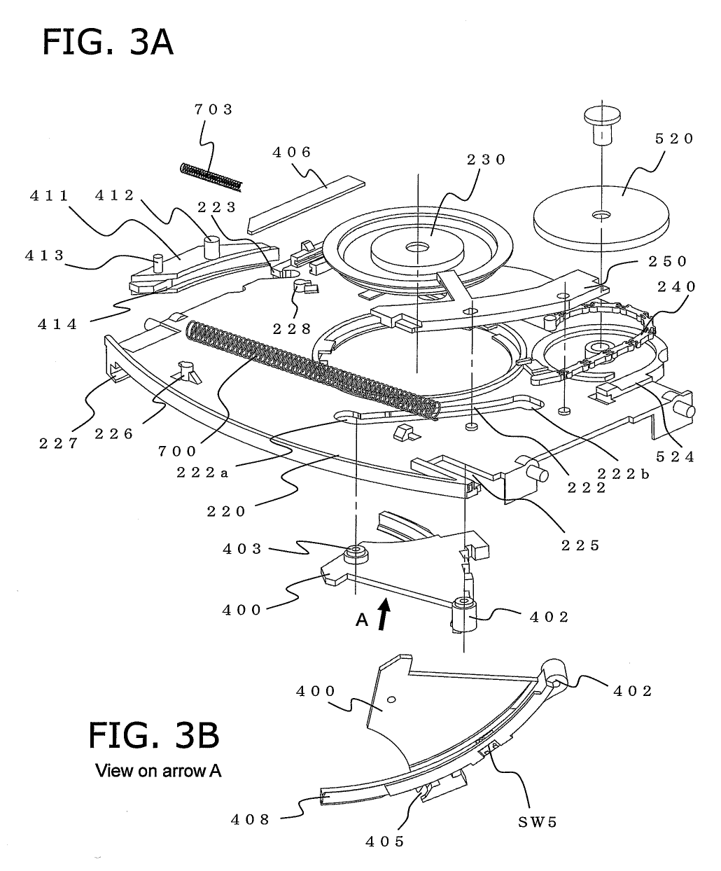

As shown in FIGS. 2, 3A, and 3B and the like, the loading mechanism 20 is formed to include a disc holder 220, the main arm 400, a sub-arm 411, and a main arm SP (first biasing member) 700 for applying a certain tension.

As shown in FIGS. 2, 3A, and 3B, the disc holder 220 includes a disc holder rotation groove 222, a disc holder control groove 225, a disc guiding groove (abutting portion) 227, and a disc holder lever release groove 223. The disc holder 220 further includes a main arm SP boss 226 for holding one end of the main arm SP 700 and a disc holder sub arm SP boss 228 for holding one end of the sub arm SP 703.

The disc holder rotation groove 222 fits to the main arm boss 403 of the main arm 400 and guides the main arm 400 in the disc insertion direction. The disc holder rotation groove 222 includes a main arm up complete holding groove 222a and a main arm down complete holding groove 222b which are substantially orthogonal to a groove forming a certain angle with the disc insertion direction.

The main arm up complete holding groove 222a has a function to prevent the main arm 400 from operating when the optical disc 102 is not yet completely attached while the optical disc 102 being inserted.

The main arm down complete holding groove 222b guides the main arm 400 in a release direction which moves away from the optical disc 102 after the optical disc 102 is clamped to the turntable 104 in order to shift the optical disc 102 to the state which allows rotation.

The disc holder control groove 225 is formed along the direction substantially perpendicular to the disc insertion direction. The disc holder control groove 225 fits to the main arm boss 402 of the main arm 400 and slides the main arm 400 in the direction substantially perpendicular to the disc insertion direction.

The disc guiding groove 227 is formed on the disc holder 220 along the disc insertion direction from the end on the left side of the disc insertion opening 101. When the optical disc 102 is inserted, the disc guiding groove 227 guides the optical disc 102 to the position where it abuts the sub arm holding portion 414 formed on the sub arm 411. The disc guiding groove 227 abuts the outer periphery of the optical disc 102 so as to pinch the optical disc 102 with the main arm 400 during the disc loading operation, which will be later described. In other words, the main arm 400 moves along a part of the outer periphery on the opposite side of the outer periphery of the optical disc 102 with a part of the outer periphery of the optical disc 102 being abutted to the disc guiding groove 227. Accordingly, the optical disc 102 can be pulled into the apparatus with a simple structure employing only one main arm 400, the main arm SP 700 and the like.

The disc holder lever release groove 223 is a notch portion formed on the left side of the disc holder 220, which fits to the sub arm boss 412 of the sub arm 411 to guide the sub arm 411 to the releasing direction.

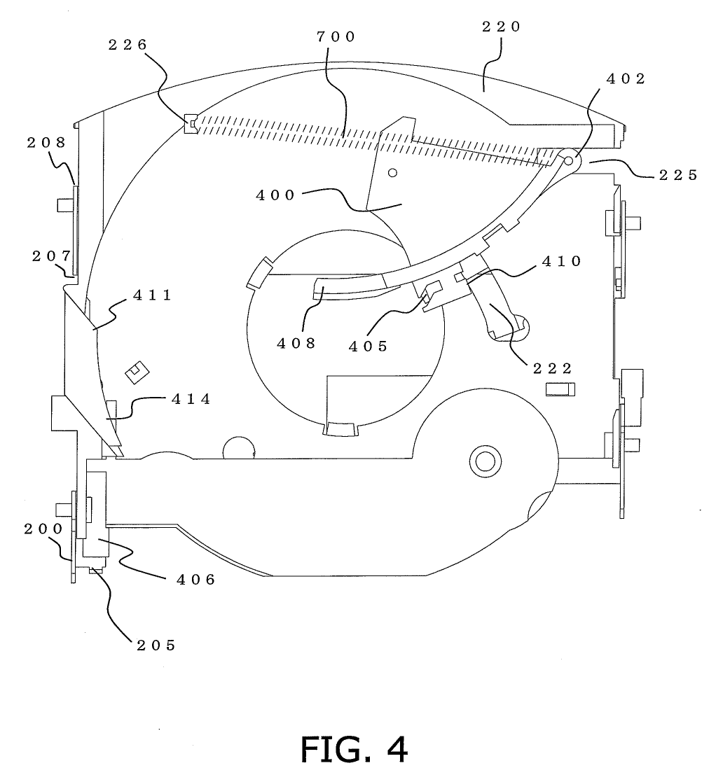

As shown in FIGS. 3A, 3B, and 4, the main arm 400 includes a main arm holding portion 408 having a substantially circular shape which abuts only to the non-recording portion of the outer periphery of the optical disc 102, main arm bosses 402 and 403, and a main arm retraction groove (retraction mechanism) 405. The main arm 400 has a shape of fan, and holds a disc front end with a main arm holding portion 408 in the first half of the process of inserting the optical disc 102. On the other hand, in the latter half of the process of inserting the disc, the main arm 400 pushes the optical disc 102 from the rear side. With such a structure, the optical disc 102 can be inserted and ejected with one arm. Accordingly, a mechanism for synchronization which is required in the structure employing two arms is no longer necessary, and thus, the apparatus can be made smaller. Furthermore, the main arm holding portion 408 can be made thinner compared to a conventional arm member as long as it has a shape which allows holding the thickness of the optical disc 102 and the upper and lower portions of the non recording surface. Moreover, since a simple structure of the one-armed mechanism is employed, a time period until disc clamping can be reduced and the standby time period is also reduced.

As shown in FIGS. 3A and 3B, between the main arm boss 402 and the disc holder main arm SP boss 226, the main arm SP 700 is provided.

The main arm 400 further includes a SW 5 for detecting insertion of the optical disc 102. The SW 5 detects insertion of the optical disc 102 when it abuts the outer periphery of the optical disc 102.

As shown in FIGS. 3A, 3B, 4, and 20A through 20C, the sub arm 411 includes a sub arm holding portion 414 of a substantially circular shape which abuts only to the non recording portion of the outer periphery of the optical disc 102, the sub arm boss 412, and the sub arm SP boss 413.

As shown in FIGS. 3A and 3B, between the sub arm SP boss 413 and the disc holder main arm SP boss 228, the sub arm SP 703 is provided.

### [Disc Clamping Mechanism 30]

As shown in FIGS. 2, 3A and 3B, the disc clamping mechanism 30 includes a holder basis (holder portion) 200, the disc holder 220, a disc damper 230, the turntable 104, a lock lever (lock mechanism) 300, the main arm 400, the sub arms 411, and the sub arm releasing lever 406.

The holder basis 200 has clamping grooves 201a, 201b, 201c, and 201d formed on end surfaces on both right and left sides. With such a structure, the disc holder 220 can be moved upward and downward by sliding the disc holder 220 in the disc insertion or ejecting directions.

The holder basis 200 further includes a disc attachment SP boss 202, a holder stopper 204, a holder hook 205, and an arm retraction holder boss 206.

A biasing spring (disc attachment SP 701) for moving the disc holder 220 downward bridges between the disc attachment SP boss 202 and a disc attachment SP boss 558 formed on an idler base 557.

The holder stopper 204 fits to the lock lever 300 to hold the disc clamp enable state.

The holder hook 205 abuts the sub arm releasing lever 406 and biases the sub arm releasing lever 406 such that the sub arm 411 and the optical disc 102 move away from each other when the holder basis 200 slides in the disc ejecting direction.

The arm retraction holder boss 206 fits to the man arm retraction groove 405 which is formed on the main arm 400 when the disc is being clamped to move the main arm 400 away from the optical disc 102.

The disc holder 220 has clamping bosses 221a, 221b, 221c, and 221d which are protruding outward on both right and left sides. The clamping grooves 201a, 201b, 201c, and 201d formed on the sides of the holder basis 200 fit to the clamping bosses 221a, 221b, 221c, and 221d, respectively.

The sub arm 411 is biased by the sub arm releasing lever 406 and moves along the disc holder lever releasing groove 223 to move away from the optical disc 102.

Further, the disc clamp mechanism 30 has a shape for holding the sub arm releasing lever 406 and a hole for holding the disc damper 230.

The disc damper 230 is located in the hole formed in the central portion of the disc holder 220 in order to fix the optical disc 102. Furthermore, the hole and the disc damper 230 both have flange so as to prevent the disc damper 230 from falling down from the hole.

The disc damper 230 and the turntable 104 form a mechanism which pinches the optical disc 102 with a magnetic force. At least one of the disc damper 230 and the turntable 104 incorporates a magnet for clamping, and the other includes a member to be attracted by the magnetic force thereof.

The disc clamp mechanism 30 is formed such that the disc damper 230 and/or the optical disc 102 does not contact the holder basis 200 and/or the disc holder 220 when the optical disc 102 is being clamped.

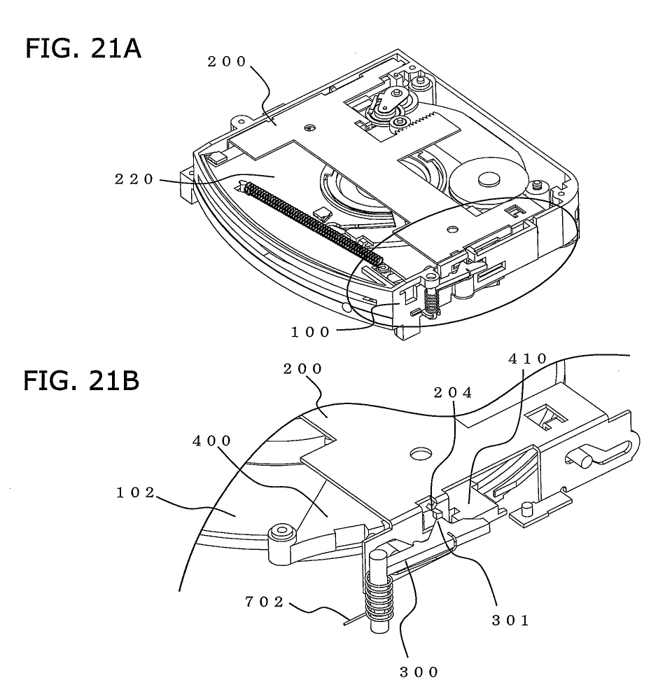

As shown in FIGS. 21A and 21B, the lock lever 300 is located at a bearing portion on a side surface of the external frame 100 such that the holder stopper 204 of the holder basis 200 and the hook fitting portion 301 are disengaged when the lock lever 300 abuts the lock releasing portion 410 of the main arm 400, which is controlled the rotation by the disc holder 220. The lock lever 300 is biased with a certain load by the lock SP 702.

### [Disc Clamp Releasing Mechanism 40]

As shown in FIGS. 2, 3A, 3B, and 16, the disc clamp releasing mechanism 40 is formed of a motor bracket unit 500, a timing belt 507, an idler arm unit 550, the holder basis 200, the disc holder 220, a gear 551, the main arm 400, and the sub arm 441.

The motor bracket unit 500 is a drive source for releasing the clamped optical disc 102, and includes a motor 501, a worm 502 press-fitted to the shaft of the motor 501, an idler gear 503, and a gear 504 having the number of the teeth which is different from that of the idler gear 503. In the motor bracket unit 500, the idler gear 503 and the gear 504 engage each other to generate a driving force.

The gear 504 includes a portion for driving the timing belt 507, a gear portion to which an unloading gear 502 engages, and a tension pulley gear 505 for adjusting the tension of the timing belt 507.

The timing belt 507 is hung between the gear 504 and the gear 551 and transmits the driving force generated by the motor bracket unit 500 from the gear 504 to the gear 521.

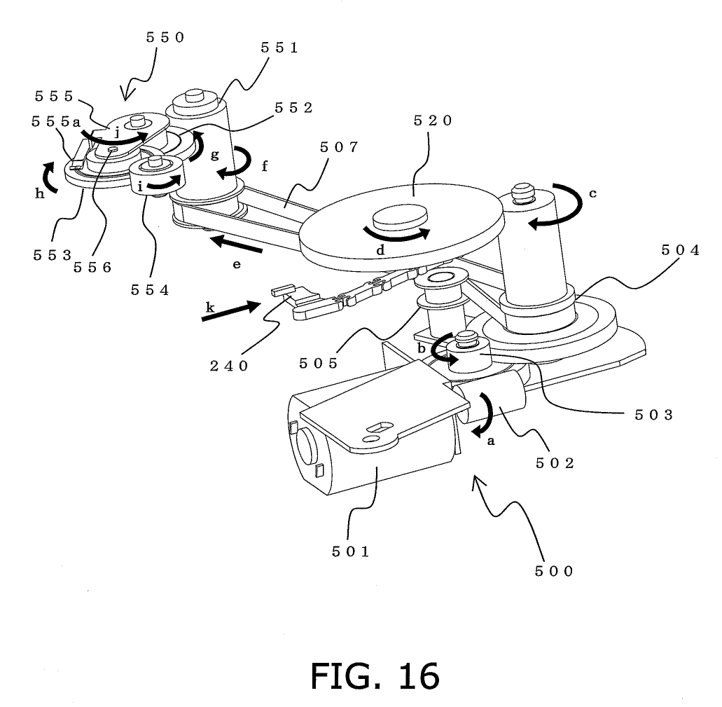

As shown in FIG. 16, the idler arm unit 550 includes a gear 552 and an idler gear 553 which engage each other, and an idler arm 555. The idler gear 553 and the idler arm 555 are held via the idler arm shaft 556.

The idler arm 555 includes an arm portion 555a for applying an appropriate load to the idler gear 553. The arm portion 555a rotates the idler arm unit 550 as the gear 552 rotates. For example, when the gear 552 rotates in the direction indicated by arrow g, the idler arm unit 550 rotates in the direction indicated by arrow j. The arm portion 555a also has a function for applying the appropriate load to the idler gear 553. A separate component (spring) or the like may be attached between the idler gear 553 and the idler arm 555 in order to provide the same function.

The holder rack 203 formed on the holder basis 200 engages to the gear 554, and transmits the driving force transmitted from the idler gear 553 to the holder basis 200 via the gear 554. In this way, the holder basis 200 slides in the disc insertion or ejecting direction.

### [Unloading Mechanism 50]

As shown in FIGS. 2, 3A, 3B, and 16, the unloading mechanism 50 is formed so as to include the motor bracket unit 500, the unloading gear 520, the disc holder 220, the push arm 240, a push arm guide 250, the main arm 400, and the sub arm 411.

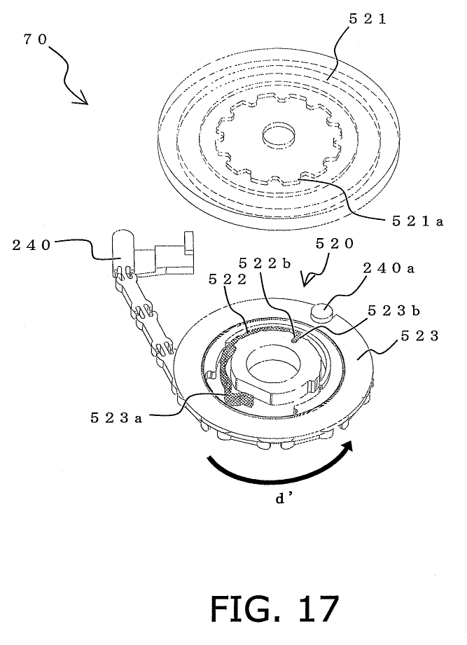

The unloading gear 520 engages to the gear 504 and is driven by the motor bracket unit 500. As shown in FIG. 17, the unloading gear 520 is formed to include the gear 521, the spring holder 523, and a lock spring (elastic portion) 522.

The gear 521 includes a gear portion which engages to the gear 504 and a fitting portion (engaging portion) 521a which are formed on an outer peripheral portion and an inner portion, respectively.

The spring holder 523 has a fitting U-shaped groove 523a which fits to a driving force transmitting portion 240a of the push arm 240 and a holding portion 523b for holding the lock spring 522.

The lock spring 522 is formed such that one end, which is a second end portion 522b, engages to the holding portion 523b and the other end, which is a first end portion 522a, engages to the fitting portion 521a inside the gear 521. The gear 521 and the spring holder 523 have a mechanism for locking with the spring 522. The lock spring 522 further has a clutch mechanism that the fitting portion 521a and the first end portion 522a of the lock spring 522 disengage when a load as large as or larger than a certain torque is applied between the gear 521 and the spring holder 523.

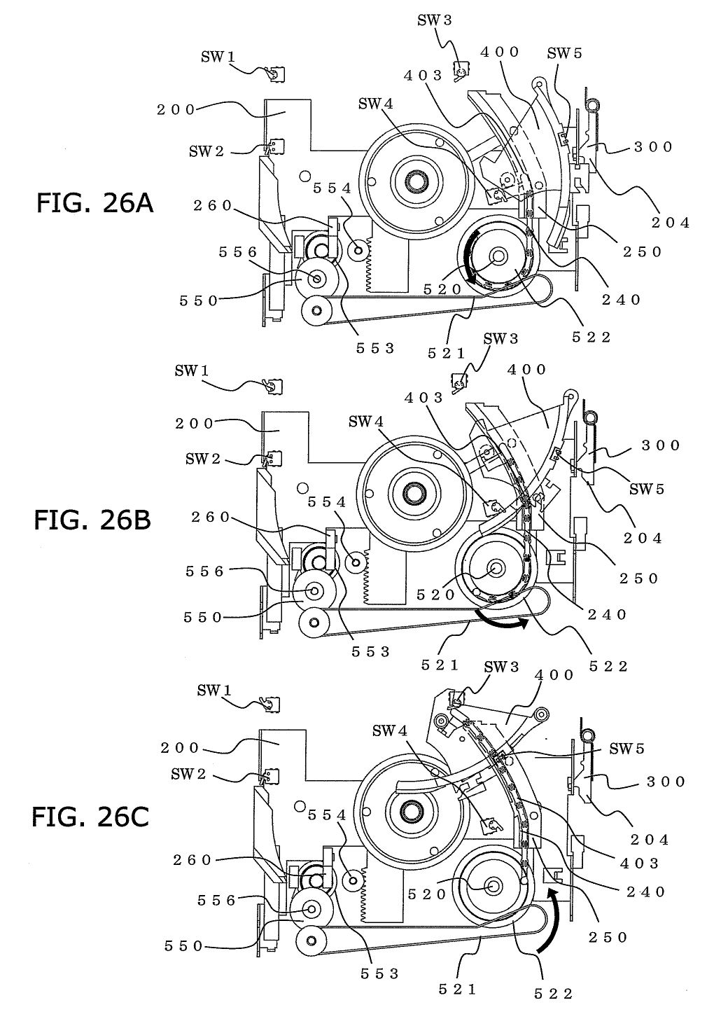

The push arm 240 can bend flexibly and, as shown in FIGS. 3A, 3B and 26A through 26C, slides along a guide rib 524 formed on the disc holder 220, an outer periphery of the spring holder 523, and an outer peripheral surface of the push arm guide 250.

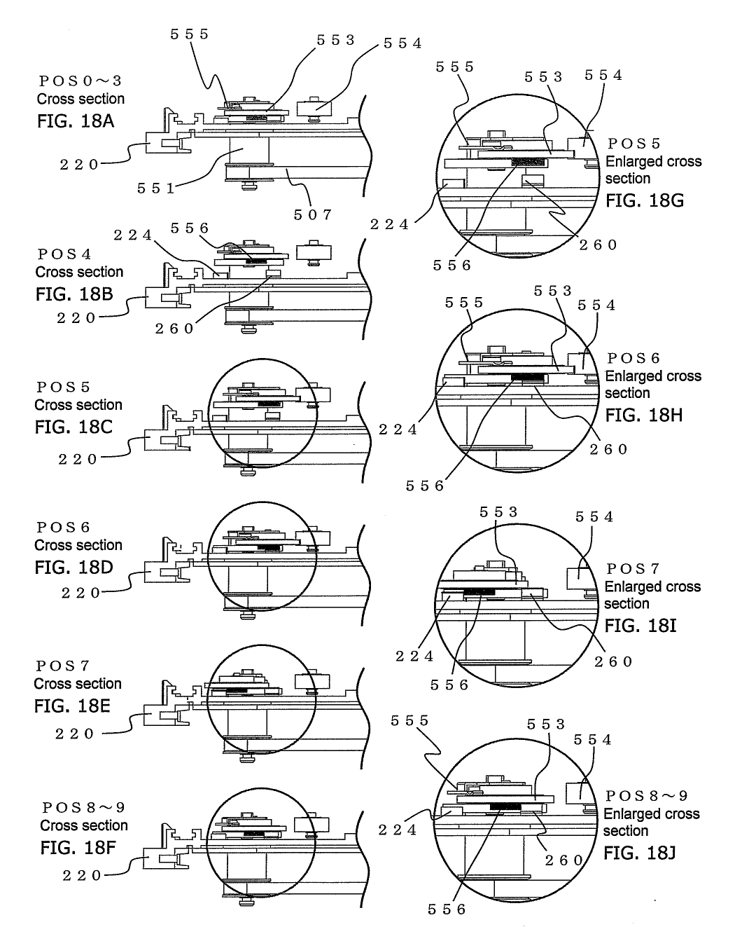

As shown in FIGS. 18A through 18J, the disc holder 220 includes the idler stopper 224 and the idler arm stopper spring 260 and abuts the idler arm shaft 556 to control rotation of the idler arm unit 550.

### [Description of Mechanism State]

Now, before the detailed description of the operations of inserting and ejecting the optical disc 102, the state of a slot mechanism is divided into nine states and defined as POS 0 through POS 9 (see FIGS. 5 through 14 for POS 0 through POS 9).

### (POS 0)

As shown in FIG. 5, POS 0 is the state where the optical disc 102 has been completely ejected, and another optical disc 102 may be inserted.

### (POS 1)

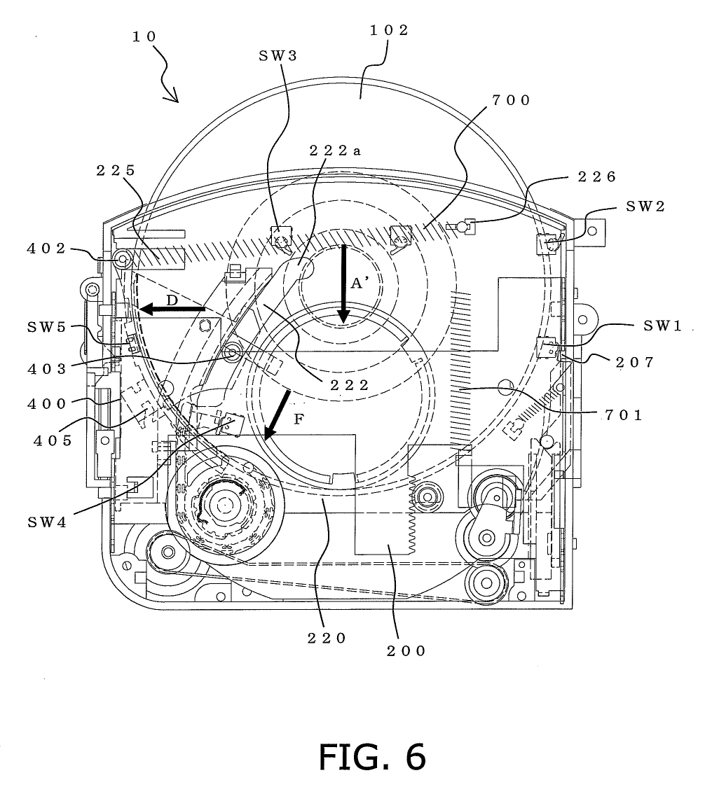

As shown in FIG. 6, POS 1 is the state from where the optical disc 102 is inserted in the direction indicated by arrow A from the state of POS 0 until when the maximum width portion of the optical disc 102 is inserted into the slot mechanism inner than the position of the main arm boss 402.

### (POS 2)

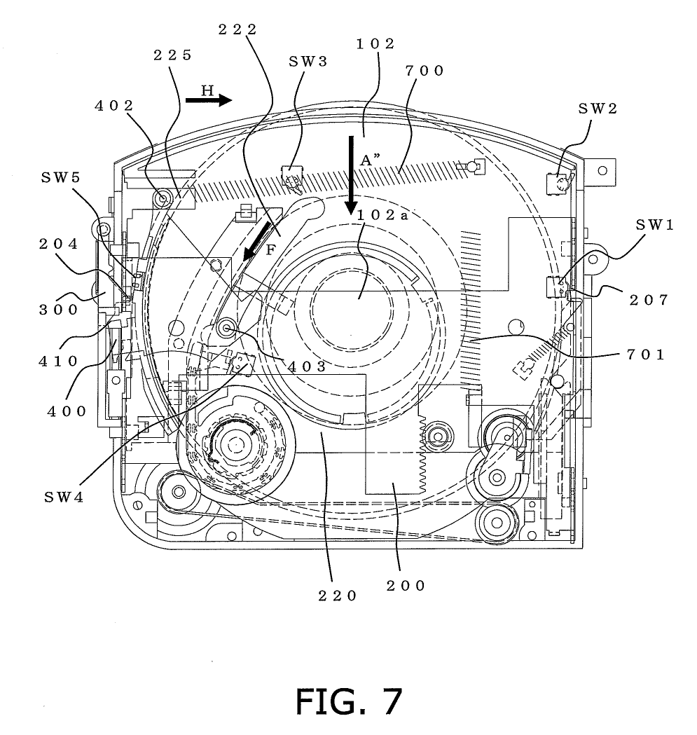

As shown in FIG. 7, POS 2 is the state where the optical disc 102 is pulled into the slot mechanism until the position of the central hole 102a of the optical disc 102 comes above the vertical axis of the turntable 104.

### (POS 3)

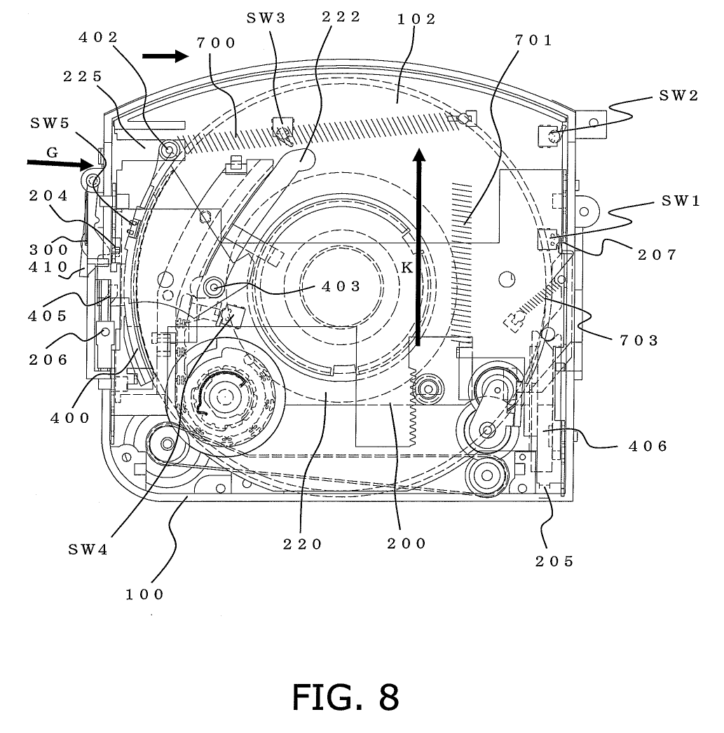

As shown in FIG. 8, POS 3 is the state where the lock releasing portion 410 attached to the main arm 400 and the lock lever 300 move from the state of POS 2 and abut each other, and the lock lever 300 and the holder stopper 204 disengage from each other by a biasing force of the main arm SP 700.

### (POS 4)

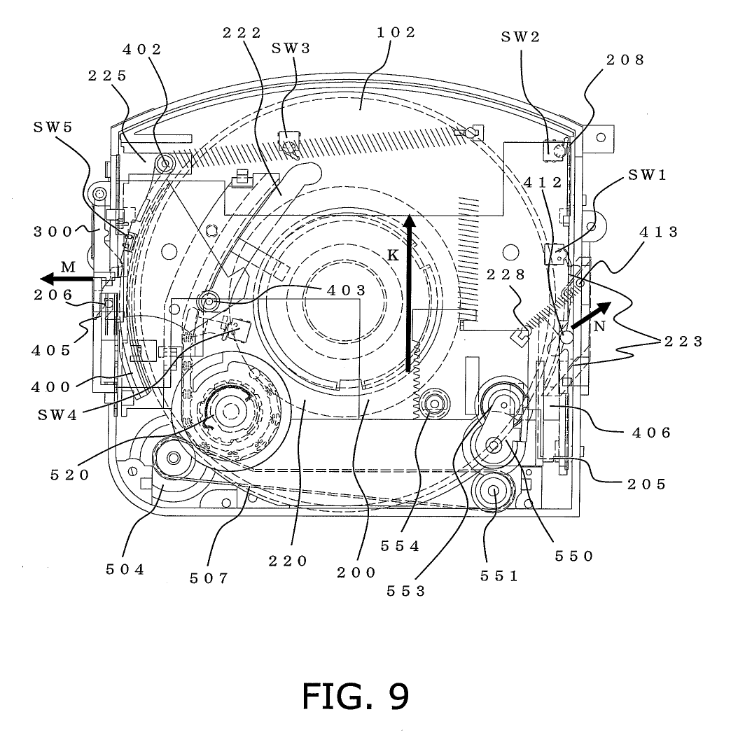

As shown in FIG. 9, POS 4 is the state where the optical disc 102 is clamped on the turntable 104 and the main arm 400 and the sub arm 411 are moved away from the optical disc 102 from the state of POS 3. In other words, the POS 4 is the state where the optical disc 102 can be spun up.

### (POS 5)

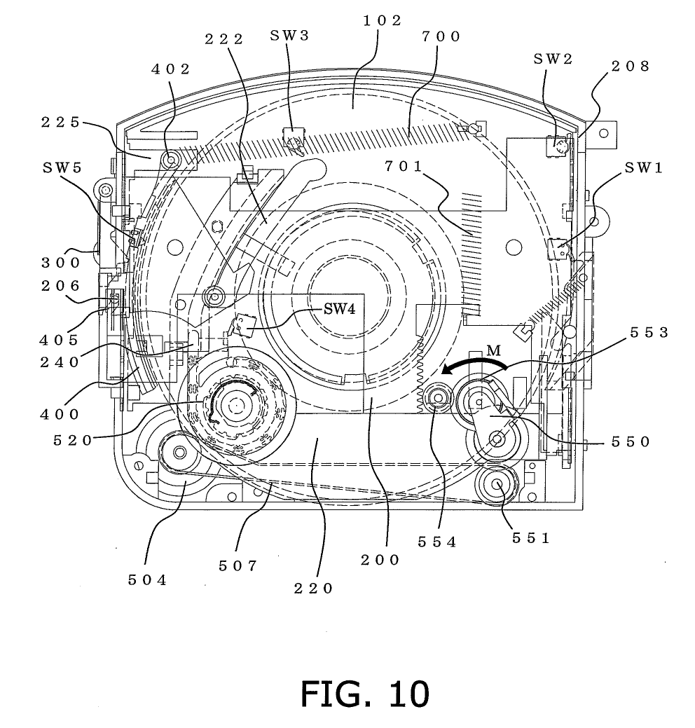

As shown in FIG. 10, POS 5 is the state where the idler arm unit 550 rotates from the state of POS 4, and the idler gear 553 and the gear 554 engage each other.

### (POS 6)

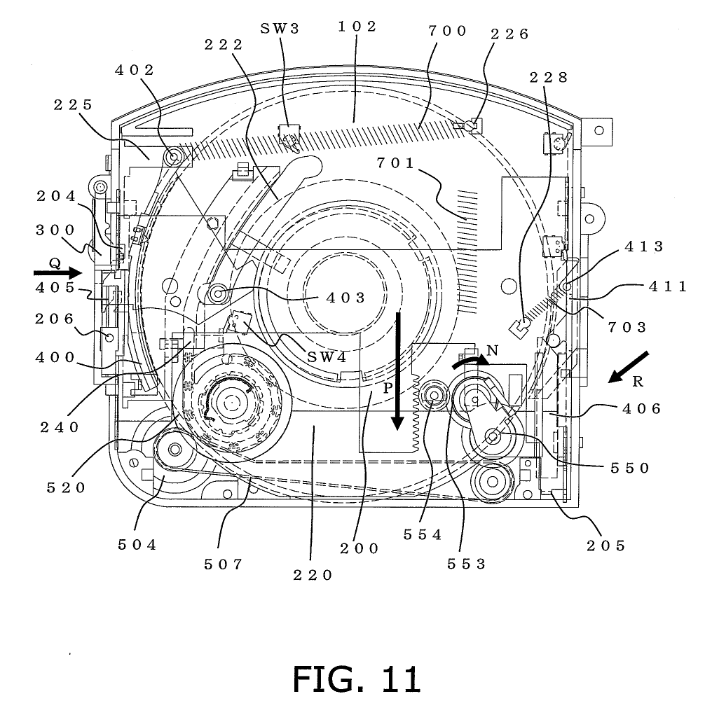

As shown in FIG. 11, POS 6 is the state where the optical disc 102 is held by the main arm 400 and the sub arm 411, and clamping is released from the turntable 104 to fit the lock lever 300 to the holder stopper 204 from the state of POS 5.

### (POS 7)

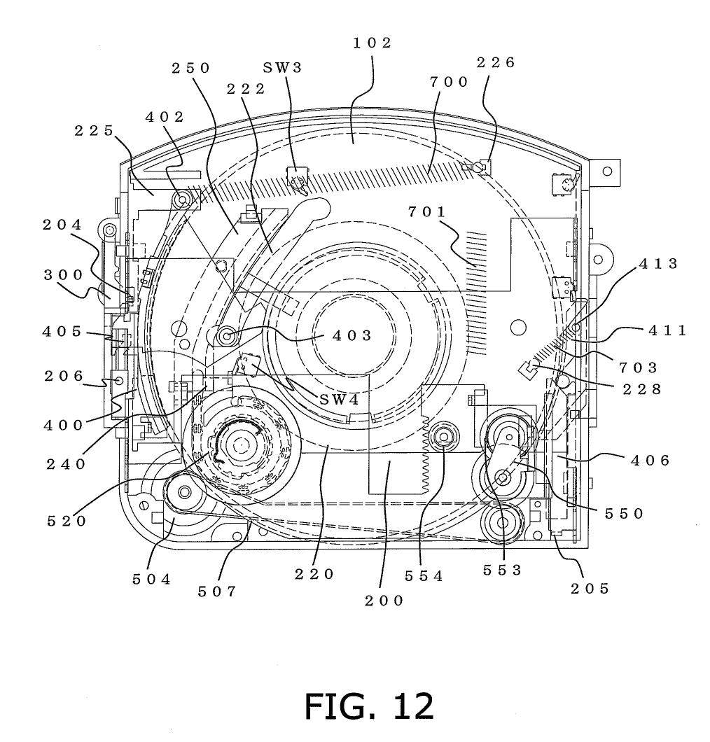

As shown in FIG. 12, POS 7 is the state where the idler arm unit 550 rotates from the state of POS 6, and the idler gear 553 and the gear 554 disengage from each other.

### (POS 8)

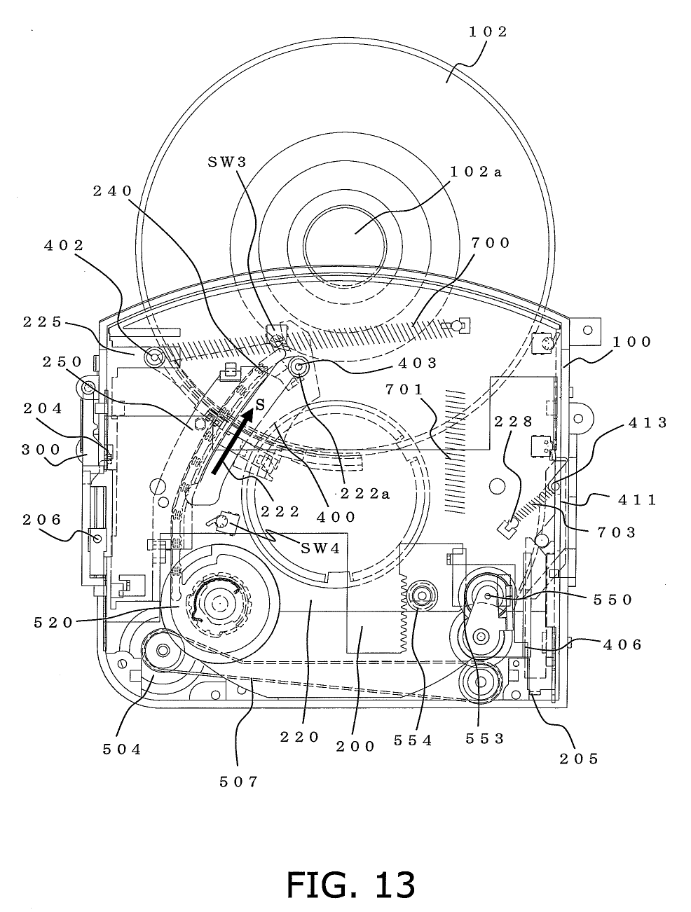

As shown in FIGS. 13 and 26C, the push arm 240 is abut the SW 3, and the optical disc 102 is ejected from the state of POS 7.

### (POS 9)

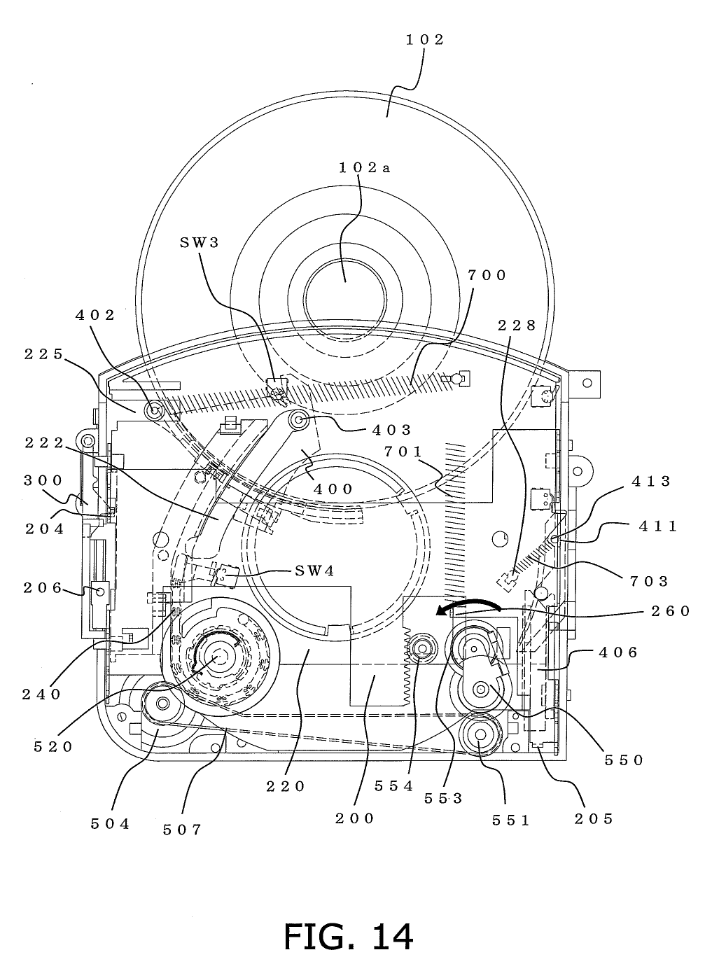

As shown in FIG. 14, POS 9 is the state where the push arm 240 is abut the SW 4, and the optical disc 102 has been ejected (state same as POS 0) from the state of POS 8.

### <Description of Operation of the Slot-In Mechanism>

The disc insertion operation and the disc ejecting operation of the slot-in mechanism in the optical disc drive apparatus 10 of the present embodiment will be described in detail below.

When the disc is being inserted, the slot-in mechanism is shifted from POS 0 to POS1, POS2, POS3, and to POS4. On the other hand, in the disc ejecting operation, the state is shifted from POS 4 to POS 5, POS 6, POS 7, POS 8, POS 9 and to POS 0.

In the disc insertion operation, the state from the POS 1 to POS 2 is referred to as a disc loading operation and the state from POS 3 to POS 4 is referred to as a disc clamping operation. On the other hand, in the disc ejecting operation, the state from POS 5 to POS 6 is referred to as a disc clamp releasing operation, and the state from POS 7 to POS 9 is referred to as a disc unloading operation.

### (Detailed Description of Disc Insertion)

Hereinafter, the disc loading operation and the disc clamping operation when a disc is inserted will be described in details.

The slot-in mechanism is waiting in the state of POS 0 as shown in FIG. 5 when the optical disc 102 is inserted.

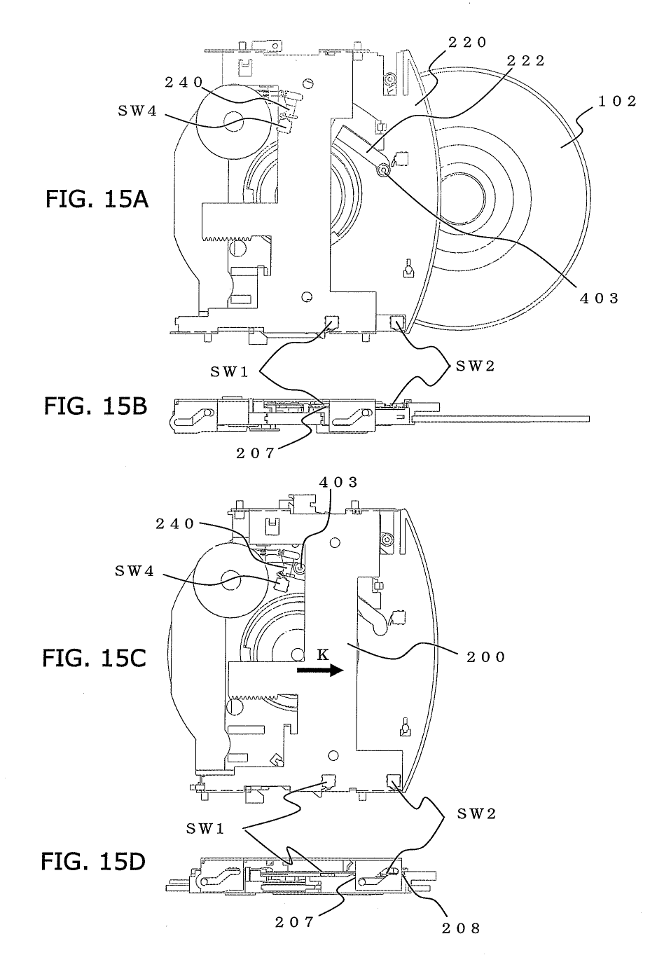

As shown in FIGS. 15A and 15B, in the state of POS 0, a disc up completion position end surface 207 formed on the holder basis 200 and the microswitch SW1 abut each other. Furthermore, a tip portion of the push arm 240 abuts to the microswitch SW4. The holder basis 200 is biased in the direction indicated by arrow K by the disc attachment SP 701. Since the lock lever 300 and the holder stopper 204 engage each other, the state of POS 0 is maintained. In this state, the idler gear 553 is remote from the gear 554. The holder basis 200 can slide in the direction indicated by arrow K by the biasing force of the disc attachment SP 701 as soon as the lock lever 300 and the holder stopper 204 are disengaged. The main arm 400 is biased in the direction indicated by arrow L by the main arm boss 402 and the main arm SP 700. Since the main arm boss 403 fits to the main arm up completion holding groove 222a of the disc holder 220, the state of the main arm 400 in POS 0 is kept.

The main arm up completion holding groove 222a is formed so as to ensure that the main arm 400 holds the optical disc 102. Specifically, when the optical disc 102 is inserted from the disc insertion opening 101, the outer periphery of the optical disc 102 abuts the main arm 400. The main arm 400 is biased by the main arm SP 700 bridging between the disc holder main arm SP boss 226 and the main arm boss 402.

If the main arm up completion holding groove 222a is not provided, the main arm boss 403 formed on the main arm 400 moves along the disc holder rotation groove 222 by a biasing force of the main arm SP 700, and the main arm 400 rotates during the insertion of the optical disc 102. In the present embodiment, the main arm up completion holding groove 222a is provided to ensure that the main arm 400 does not rotate until the optical disc 102 is completely inserted and is held by the main arm 400.

In the slot-in mechanism in the POS 0 state, as the optical disc 102 is inserted from the disc insertion opening 101, the outer peripheral end of the optical disc 102 abuts the microswitch SW 5 (see FIG. 5) incorporated in the main arm 400, and the microswitch SW 5 is turned on. In this way, the insertion of the optical disc 102 can be detected and the start of the disc loading operation can be detected.

(Disc Loading Operation)

In the state of POS1 as shown in FIG. 6, the main arm 400 is pushed and spread by the optical disc 102 which is inserted in the direction indicated by arrow A shown in FIG. 5. At the same time, the main arm boss 402 slides in the direction indicated by arrow D along the disc holder control groove 225, and the main arm boss 403 slides in the direction indicated by arrow F along the disc holder rotation groove 222.

When the positions of the maximum width portion of the optical disc 102 and the main arm boss 402 are as shown in FIG. 6, the main arm SP 700 bridging between the main arm boss 402 and the disc holder main arm SP boss 226 has the maximum tension.

When the optical disc 102 is further inserted from the state of POS 1, as shown in FIG. 7, the tension of the main arm SP 700 causes the main arm boss 402 attached to the main arm 400 and the main arm boss 403 slide in the direction indicated by arrow H and the direction indicated by arrow F, respectively. Until the position of the center hole 102a of the optical disc 102 comes above the turntable 104, the optical disc 102 is pulled into the slot mechanism and the state of POS 2 is achieved.

POS 2 is the state where the fitting between the lock lever 300 and the holder stopper 204 is being disengaged by the biasing force of the main arm SP 700, shifted from the state where the lock releasing portion 410 provided on the main arm 400 fits to the lock lever 300 to the state.

POS 3 is the state where the main arm 400 is rotated by the biasing force of the main arm SP 700 from the state of POS 2, and the lock lever 300 and the holder stopper 204 are disengaged by the lock releasing portion 410 of the main arm 400.

As shown in FIG. 8, in POS 3, the holder basis 200 is biased in the direction indicated by arrow K by the disc attachment SP 701 which is hung between the holder basis 200 and the external frame 100. Thus, when the lock lever 300 and the holder stopper 204 are disengaged, the holder basis 200 starts to slide in the direction indicated by arrow K. At this time, as shown in FIGS. 15C and 15D, the microswitch SW1 and the up completion position end surface 207 formed on the holder basis 200 move away from each other, it can be detected that the operation is shifted to the disc clamping operation.

### (Disc Clamping Operation)

In the disc clamping operation, the optical disc 102, which has been moved in the horizontal direction from the disc insertion opening 101 to the position in POS 3, is moved downward in the vertical direction.

From the state of POS 3 (see FIG. 8), the holder basis 200 slides in the direction indicated by arrow K to enter the state of POS 4 (see FIG. 9).

As shown in FIG. 2, the clamping bosses 221a, 221b, 221c, and 221d of the disc holder 220 fit to the clamping grooves 201a, 201b, 201c, and 201d of the holder basis 200. Thus, as shown in FIG. 8, the holder basis 200 slides in the direction indicated by arrow K and moves the disc holder 220 downward in the vertical direction with respect to the disc insertion direction.

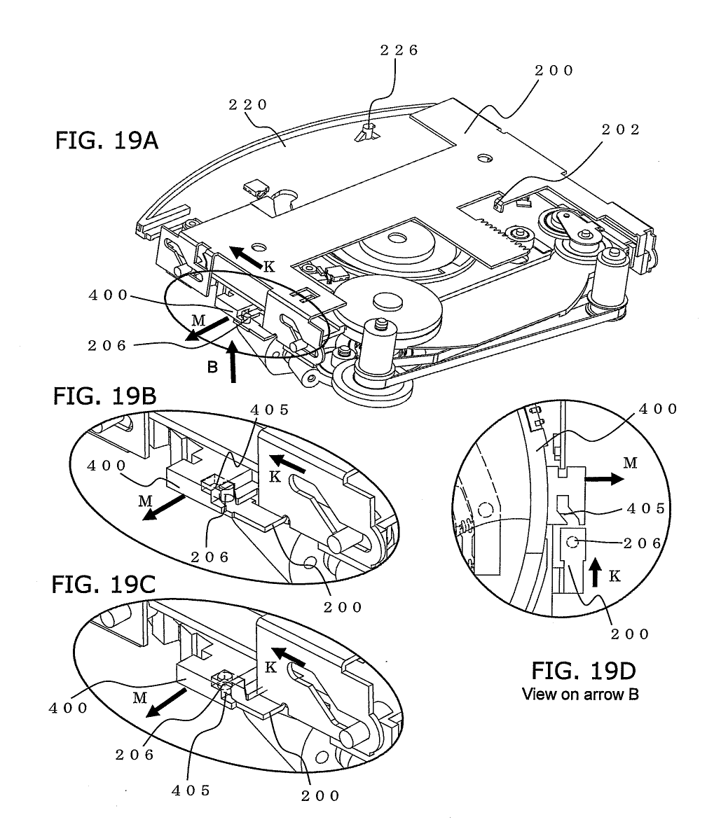

As the holder basis 200 further slides in the direction indicated by arrow K, the main arm retraction groove 405 of the main arm 400 and the arm retraction holder boss 206 fit as shown in FIGS. 19A through 19D. With such fitting, the main arm 400 moves in the direction indicated by arrow M following the configuration of the main arm retraction groove 405. In this way, the main arm 400 and the optical disc 102 can be moved away from each other.

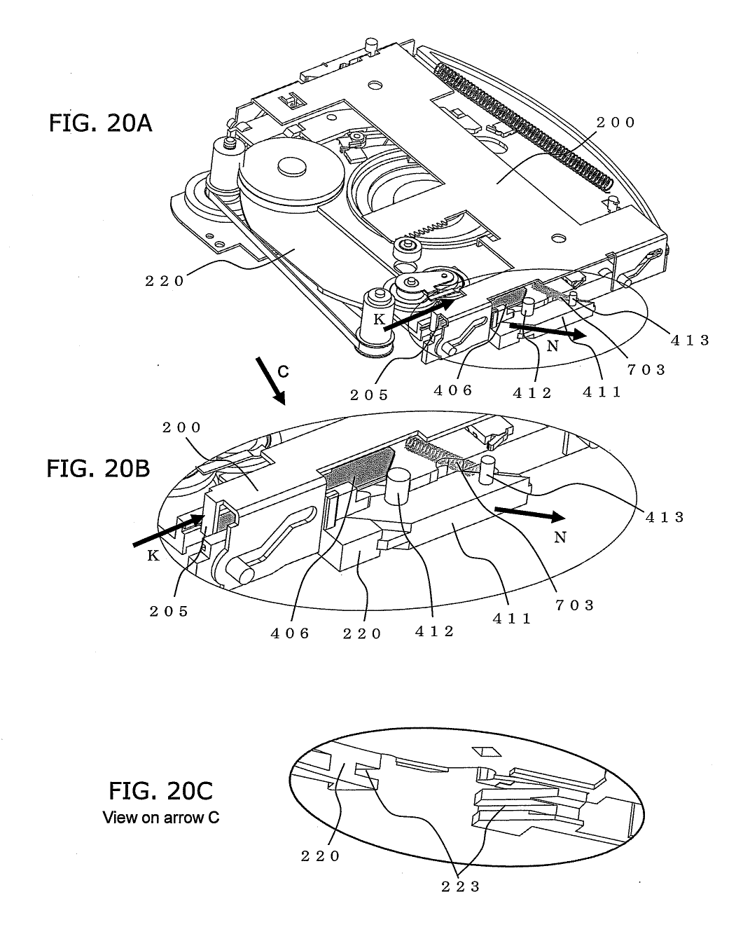

As shown in FIGS. 20A through 20C, the holder hook 205 located on the holder basis 200 and the sub arm releasing lever 406 located on the disc holder 220 abut each other, and the sub arm releasing lever 406 slides in the direction indicated by arrow K. Accordingly, the sub arm releasing lever 406 abuts the sub arm boss 412. The sub arm releasing lever 406 has an inclined portion at the portion which abuts the sub arm boss 412. The sub arm 411 moves in the direction indicated by arrow N along the disc holder lever releasing groove 223 of the holder basis 200 as the sub arm boss 412 is pushed in the direction indicated by arrow N by the inclined portion, and thus, moves away from the optical disc 102.

Almost at the same time as the sub arm 411 is detached from the optical disc 102, the disc damper 230 located in the disc holder 220 and the turntable 104 pinch and fix the optical disc 102 with a magnetic force.

As shown in FIGS. 15C and 15D, when the movement of the holder basis 200 sliding in the direction indicated by arrow K is finished, the switch SW2 located on the disc holder 220 and the down completion position end surface 208 of the holder basis 200 abut each other and the switch SW2 is turned on. When the SW2 is detected to be on, it is determined that the disc clamping operation is completed, and the state of POS 4 is achieved.

At this time, as shown in cross sections of the POS0 through POS3 states (see FIG. 18A) and a cross section of the POS 4 state (see FIG. 18B), when the disc holder 220 finishes sliding, the idler arm stopper spring 260 and the idler stopper 224 located on the disc holder 220 move down to free the idler arm unit 550 from the controlled state.

With the operation as described above, the optical disc 102 is clamped on the turntable 104, and the optical disc 102 is ready for being spun up.

### (Detailed Description of Disc Ejecting)

Now, the disc clamp releasing operation and the disc unloading operation when the disc is being ejected are described in detail.

For ejecting the optical disc 102, since the slot-in mechanism is in the state of POS 4 as shown in FIG. 9, the disc clamp releasing operation has to be performed while the disc is being stopped.

### (Disc Clamp Releasing Operation)

In the disc clamp releasing operation, as shown in FIG. 10, from the state of POS 4, the motor 501 is rotated to rotate the idler arm unit 550 in the direction indicated by arrow M, and the idler gear 553 and the gear 554 are engaged to shift to the state of POS 5.

More specifically, the transmission of rotation from the motor 501 to the gear 554 is as follows. As shown in FIG. 16, the motor 501 rotates the worm 502 in the direction indicated by arrow a. The idler gear 503 which engages with the worm 502 is rotated in the direction indicated by arrow b, and the gear 504 which engages with the idler gear 503 rotates in the direction indicated by arrow c. To the gear 504, the timing belt 507 for transmitting rotation to the gear 551 is attached. When the gear 504 rotates in the direction indicated by arrow c, the timing belt 507 rotates in the direction indicated by arrow e, and the gear 551 rotates in the direction indicated by arrow f. As the gear 551 rotates in the direction indicated by arrow f, the gear 552 rotates in the direction indicated by arrow g and the idler gear 553 rotates in the direction indicated by arrow h, respectively. As the gear 552 rotates in the direction indicated by arrow g, the idler arm unit 550 rotates in the direction indicated by arrow j, and the idler gear 553 and the gear 554 can be engaged to each other.

Now, when the state is shifted to POS 5, the gear 504 and the unloading gear 520 engage each other. Thus, the unloading gear 520 rotates in the direction indicated by arrow d, and the push arm 240 fitted thereto is moved in the direction indicated by arrow k. At this time, even the push arm 240 moves, as shown in FIG. 10, the push arm 240 and SW4 remain abutting, and the SW4 remains on.

As the motor 501 further rotates from the state of POS 5, the idler gear 553 rotates in the direction indicated by arrow N with being engaged with the gear 554 as shown in FIG. 11. At this time, the gear 554 and the holder rack 203 formed on the holder basis 200 engage each other. Thus, the holder basis 200 starts to slide in the direction indicated by arrow P.

Next, as the holder basis 200 slides in the direction indicated by arrow P, the arm retraction holder boss 206 and the main arm retraction groove 405 for retracting the arm disengage from each other. Since the main arm 400 is biased in the direction indicated by arrow Q by the main arm SP 700, it abuts the optical disc 102. Almost at the same time, the biasing force applied to the sub arm releasing lever 406 by the holder hook 205 formed on the holder basis 200 is released. The sub arm 411 slides in the direction indicated by arrow R and abuts to the optical disc 102 by the biasing force of the sub arm SP 703 which bridges the sub arm SP boss 413 and the disc holder sub arm SP boss 228.

As the holder basis 200 further slides in the direction indicated by arrow P, the clamping bosses 221a, 221b, 221c, and 221d of the disc holder 220 slide along the clamping grooves 201a, 201b, 201c, and 201d of the holder basis 200. In this way, the disc holder 220 moves upward with respect to the disc insertion direction to move the disc damper 230 located in the disc holder 220 away from the turntable 104 to release the clamped optical disc 102.

Since the disc holder 220 moves upward at this time, the state of POS 5 (see FIGS. 18C and 18G) changes to the state of POS 6 (FIGS. 18D and 18H). As shown in an enlarged view of the cross section of POS5 (see FIG. 18G), the idler stopper spring 260 is located on an upper surface of the disc holder 220 below the idler arm shaft 556 in the vertical direction with the idler gear 553 and the gear 554 being engaged to each other. When the disc holder 220 is moving up, the idler stopper spring 260 abuts a lower plane surface of the idler arm shaft 556 and is compressed to become the state shown in an enlarged view of the cross section of POS 6.

As the holder basis 200 further slides in the direction indicated by arrow P, as shown in FIGS. 21A and 21B, the lock lever 300 biased by the lock SP 702 and the holder stopper 204 of the holder basis 200 engage each other to hold the holder basis 200.

As shown in FIGS. 15A and 15B, the switch SW1 located on the disc holder 220 and the up completed position end surface 207 of the holder basis 200 abut each other and the switch SW1 is turned on. Thus, it is detected that the disc clamp releasing operation is finished.

When it is detected that the disc clamp releasing operation is finished, rotation of the motor bracket unit 500 is stopped.

With the operation as described above, the clamped optical disc 102 is released on the turntable 104, and the state of POS 6 as shown in FIG. 11 is obtained.

### (Disc Unloading Operation)

In the disc unloading operation, from the state of POS 6, the motor 501 is rotated in the direction opposite to arrow a as shown in FIG. 16, and the idler arm unit 550 is rotated in the direction indicated by arrow N as shown in FIG. 11. The gear 554 and the idler gear 553 are disengaged and the state of POS 7 as shown in FIG. 12 is achieved.

At this time, since the gear 552 rotates in the direction opposite to arrow g as shown in FIG. 16 and the idler arm 555 rotates in the direction opposite to arrow j as shown in FIG. 16, an end surface of the idler arm shaft 556 and the idler stopper 224 abut each other. Accordingly, the idler stopper spring 260 is released from the compressed state (see FIG. 18I).

From the state of POS 7, as the motor 501 is further rotated in the direction opposite to arrow a as shown in FIG. 16, since the gear 504 and the unloading gear 520 engage each other, the unloading gear 520 rotates in the direction opposite to arrow d. At this time the push arm 240 fitting to the unloading gear 520 moves in the direction opposite to arrow k. As shown in FIG. 12, the push arm 240 is controlled by the push arm guide 250, and thus, abuts the main arm boss 403 along the push arm guide 250. Further, as the unloading gear 520 rotates, the push arm 240 moves the main arm 400 in the direction indicated by arrow S as shown in FIG. 13 by moving the main arm boss 403 along the disc holder rotation groove 222. As the main arm 400 moves to the position of the main arm up completion holding groove 222a, a tip of the push arm 240 abuts the switch SW3 and turns on the switch SW3. When it is detected that the switch SW3 is turned on, the motor 501 stops and the state of POS 8 is achieved.

The state of POS 8 is the state where the central hole 102a of the optical disc 102 is ejected outside the disc insertion opening 101 of the external frame 100, and the optical disc 102 is completely ejected.

While the state is being shifted from POS 7 to POS 8, if the optical disc 102 is ejected until the main arm boss 402 abuts the maximum diameter position of the optical disc 102, the main arm 400 ejects the optical disc 102 by the biasing force of the main arm SP 700. The mechanism for preventing the optical disc 102 from jumping out during such an ejecting operation will be later described in detail.

From the state of POS 8, as the motor 501 is rotated in the direction indicated by arrow a as shown in FIG. 16, the unloading gear 520 rotates in the direction indicated by arrow d since the gear 504 and the unloading gear 520 engage each other. In this way, the push arm 240 which fits to the unloading gear 520 is moved in the direction indicated by arrow k.

Next, as the motor 501 is rotated in the direction indicated by arrow a, the gear 504, the timing belt 507 and the gear 551 rotate in the directions indicated by arrow c, arrow e, and arrow f, respectively. As the gear 551 rotates in the direction indicated by arrow f, the idler arm unit 550 rotates in the direction indicated by arrow j. At this time, once the idler gear 553 engages with the gear 554, rotation of the gear 504 and the like is locked since the holder basis 200 has already been moved to the disc clamp releasing position.

Therefore, in the optical disc drive apparatus 10 according to the present embodiment, the idler stopper spring 260 and the end surface of the idler arm shaft 556 abut each other as shown in cross sections of POS 8 to POS9 (see FIG. 18F), and enlarged views of cross sections of POS 8 to POS 9 (see FIG. 18J). In this way, the idler gear 553 and the gear 554 are controlled so as not to engage, and the rotational driving force of the gear 504 is transmitted only to the unloading gear 520. When the unloading gear 520 rotates in the direction indicated by arrow d as shown in FIG. 16, the push arm 240 is moved in the direction indicated by arrow k as shown in FIG. 16 and wound by the unloading gear 520.

As push arm 240 moves the main arm boss 403 to the position where the optical disc 102 is completely ejected, the main arm boss 403 fits to the main arm up completion holding groove 222a. Then, the main arm SP 700 bridging between the disc holder main arm SP boss 226 and the main arm boss 402 biases the push arm 240. The main arm up completion holding groove 222a is formed in a direction substantially orthogonal to the disc holder rotation groove 222 which forms a certain angle to the disc insertion direction in the disc holder 220. With such a structure, even when the push arm 240 is wound to the unloading gear 520, the optical disc 102 can remain ejected.

As shown in FIG. 14, a part of the push arm 240 abuts the switch SW4 and it is detected that the switch SW4 is turned on, the rotation of the motor 501 is stopped and the state of POS 9 is achieved.

When the state of POS 9 is detected, the disc ejecting operation is completed, and the state shifts to the state of POS 0, which is a standby state for insertion.

In the optical disc drive apparatus 10 according to the present embodiment, discs can be inserted/ejected in the slot-in mechanism with the operations which have been described above.

### [Disc Jumping-Out Prevention Mechanism 60]

As described above, in the optical disc drive apparatus 10 according to the present embodiment, when the optical disc 102 is ejected from the disc insertion opening 101, the optical disc 102 may jump out as will be described below. More specifically, when the maximum diameter position of the optical disc 102 is ejected outside the main arm boss 402, the main arm 400 may further bias the optical disc 102 by the biasing force of the main arm SP 700 and the optical disc 102 may jump out from the disc insertion opening 101.

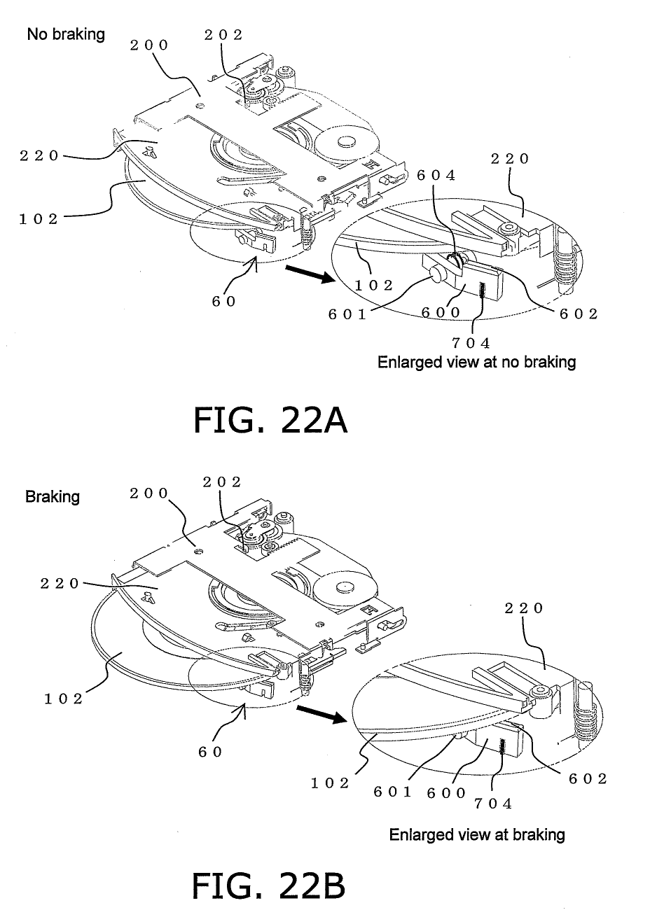

Accordingly, in the present embodiment, as shown in FIGS. 22A and 22B, the disc jumping-out prevention mechanism 60 is provided inside the external frame 100 (not shown).

As shown in FIGS. 22A and 22B, the disc jumping-out prevention mechanism 60 has the disc braking lever 600, a rotational shaft 601, a disc contact portion 602, the disc biasing SP 704, and the external frame 100 (see FIG. 1).

The disc braking lever 600 is supported in the rotational shaft 601 in a direction substantially parallel to the longitudinal direction of the disc insertion opening 101. The disc braking lever 600 is fixed inside the external frame 100 near the right end of the disc insertion opening 101 in the state it can rotate in the direction substantially perpendicular to the disc insertion direction. The disc braking lever 600 further has a biasing spring (the disc biasing SP 704) attached thereto so as to abut the optical disc 102 with a certain force.

The disc braking lever 600 may be attached such that it biases one of upper or lower surfaces of the optical disc 102, or may be attached such that it biases both the upper and lower sides. Furthermore, the disc braking lever 600 may be provided on both right and left ends of the disc insertion opening 101.

The disc contact portion 602 abuts a part of the optical disc 102 and applies a desired braking force to the optical disc 102. The disc contact portion 602 is attached such that it inclines by a certain angle with respect to the longitudinal direction of the disc insertion opening 101. Such inclination causes a contact portion between the outer periphery of the optical disc 102 and the disc contact portion 602 to vary in accordance with the position of the optical disc 102 as it is inserted/ejected from the disc insertion opening 101. The disc contact portion 602 has an angle which allows it to abut only to the outer periphery of the optical disc 102 and not to abut the recording surface. The inclination of the disc contact portion 602 may be provided when the disc contact portion 602 is formed as a part of the disc braking lever 600, or may be provided by adjusting relative positions of the disc braking lever 600 and the external frame 100 (hereinafter, the outer periphery of the optical disc 102 is referred to as a braked portion and a portion where the braked portion and the disc contact portion 602 contact each other is referred to as a braking contact portion).

### <Description of Operations>

Now, the operations of the disc jumping-out prevention mechanism 60 when a disc is being ejected are described in detail.

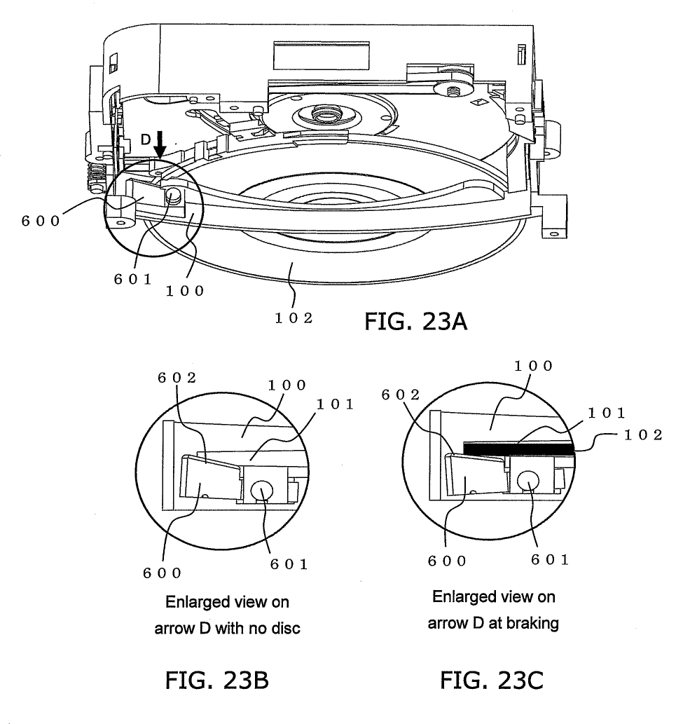

As shown in FIGS. 23A through 23C, the disc braking lever 600 is attached so as to block a part of width of the disc insertion opening 101 at the right end of the disc insertion opening 101.

When the optical disc 102 is started to be ejected from the disc insertion opening 101, the width of the optical disc 102 passing through the position of the disc insertion opening 101 becomes wider as it is being ejected. When the optical disc 102 is ejected to the position where braking by the disc braking lever 600 is started, the disc contact portion 602 and the braked portion of the optical disc 102 contact each other (hereinafter, this contact position is referred to as a braking start position).

As the optical disc 102 is further ejected, the contact portion between the disc contact portion 602 and the braked portion of the optical disc 102 moves so as to become closer to an end of the disc insertion opening 101 on the disc contact portion 602 as shown in FIG. 23C. At this time, since the disc contact portion 602 is inclined so as to contact only to the braked portion of the optical disc 102, the disc braking lever 600 gradually rotates and the biasing force of the disc biasing SP 704 increases.

When the optical disc 102 is ejected to the position where the maximum diameter position of the optical disc 102 passes the disc insertion opening 101, the contact portion as mentioned above is moved to the position most remote from the braking start position on the disc contact portion 602 (hereinafter, the contact position is referred to as the braking middle position).

Since the disc contact portion 602 is inclined such that it contacts only the braked portion of the optical disc 102, the degree of rotation of the disc braking lever 600 becomes maximum and the biasing force of the disc biasing SP 704 also becomes maximum.

As the optical disc 102 is further ejected, the contact portion of the disc contact portion 602 with the braked portion of the optical disc 102 moves from the braking middle position to the braking start position on the disc contact portion 602. At the same time, the degree of the rotation of the disc contact portion 602 gradually decreases, and the biasing force of the disc biasing SP 704 also decreases.

At the position where the disc unloading operation finishes and the ejecting operation of the optical disc 102 finishes, the disc braking lever 600 abuts the optical disc 102 Thus, the disc braking lever 600 can also serve as a retaining mechanism for preventing the optical disc 102 from falling down from the disc insertion opening 101 (hereinafter, the braking contact portion of the disc contact portion 602 with the optical disc 102 when the disc unloading operation is finished is referred to as the braking end position).

Now, a method for applying a desired braking force to the disc braking lever 600 at the ejecting completion position of the optical disc 102 is described.

As described above, in accordance with the position of the optical disc 102 as being ejected, the contact portion moves from the braking start position to the braking middle position and the braking end position on the disc contact portion 602. Thus, in accordance with the position of the optical disc 102 during the ejecting process of the optical disc 102, the braking force which is applied to the optical disc 102 can be altered.

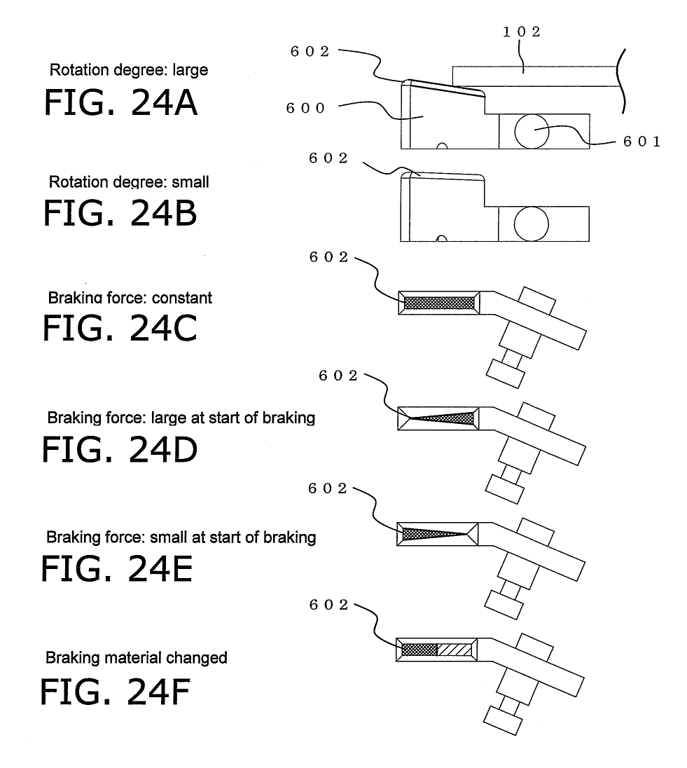

Specifically, as shown in FIGS. 24A (large rotation degree) and 24B (small rotation degree), as the degree of the rotation of the disc braking lever 600 changes in accordance with the position of the optical disc 102 in the ejecting process, the angle of inclination of the disc contact portion 602 changes. Accordingly, as the biasing force of the disc biasing SP 704 changes in accordance with the degree of the rotation of the disc braking lever 600, the contact pressure of the contact portion may be increased to increase the braking force.

In the optical disc drive apparatus 10 according to the present embodiment, the disc contact portion 602 may be formed to have a substantially rectangular shape as shown in FIG. 24C so as to have the constant braking force from the braking start position to the braking middle position and the braking end position. Alternatively, as shown in FIG. 24D, the disc contact portion 602 may be formed to have a substantially triangle shape such that the braking force becomes strong at the braking start position, becomes weak at the braking middle position, and becomes large enough to prevent the optical disc 102 from falling down from the disc insertion opening 101 at the braking end position. On the contrary, as shown in FIG. 24E, the disc contact portion 602 may be formed to have a substantially triangle shape in the opposite direction such that the braking force becomes weak at the braking start position, becomes maximum at the braking middle position, and becomes weak to the degree that it can prevent the optical disc 102 from falling down from the disc insertion opening 101 at the braking end position.

In other words, by adjusting the area of contact of the contact portion of the disc contact portion 602 from the braking start position to the braking middle position at the ejecting position of the optical disc 102, a desired braking force can be obtained at any position during the ejecting process.

Furthermore, as shown in FIG. 24F, a material of the contact portion of the disc contact portion 602 with the optical disc 102 may be partially changed (for example, by performing surface finishing such as hatching or the like, adhering felt, and so on, near the braking middle position) to radically increase or degrease the braking force to be applied to the optical disc 102 from other positions.

### [Overload Control Mechanism 70]

In the optical disc drive apparatus 10 according to the present embodiment, the optical disc 102 is ejected from the disc insertion opening 101 by the main arm 400 in the disc unloading operation. During such an operation, if an overload is applied to push the optical disc 102 in the disc insertion direction, the overload may be transmitted from the main arm 400 to the push arm 240 and may damage the disc unloading mechanism 50.

Thus, in the optical disc drive apparatus 10 according to the present embodiment, as shown in FIG. 17, the overload control mechanism 70 is provided in order to prevent damage of the disc unloading mechanism 50.

As shown in FIG. 17, the overload control mechanism 70 includes the unloading gear (gear) 520 and the gear 521.

The unloading gear 520 incorporates the lock spring (elastic portion) 522 and the spring holder 523.

The gear 521 has a gear portion formed on an outer periphery end surface, which fits to the gear 504 for transmitting a motive power from the motor 501. The gear 521 has the fitting portion 521a which fits to the lock spring 522 on the gear inner peripheral portion.

The spring holder 523 has an indented portion in which the drive transmission portion 240a of the push arm 240 can be accommodated, and to which the drive transmission portion 240a fits. The spring holder 523 also has a holding portion for holding the holding portion 523b of the lock spring 522.

The overload control mechanism 70 is formed such that the fitting portion 521a of the gear 521 fits to the lock spring 522 with the lock spring 522 being held by the spring holder 523 at the unloading gear 520 with the above-described structure.

### <Description of Operations>

Now, operations of the overload control mechanism 70 when the optical disc 102 being ejected are described in detail.

If an overload in the insertion direction is applied to the optical disc 102 while the optical disc 102 is being ejected, the overload is transmitted to the main arm 400. The overload transmitted to the main arm 400 is transmitted to the spring holder 523 via the push arm 240 which drives the main arm 400 in the ejecting direction.

The spring holder 523 is fitting to the gear 521 via the lock spring 522. If the overload transmitted to the spring holder 523 has a predetermined degree or larger, the lock spring 522 and the fitting 521a of the gear 521 disengage from each other and the spring holder 523 runs idle (hereinafter, the overload of the minimum degree which causes idle running is referred to as load releasing force). This idle running releases the transmitted overload, and damage to the unloading mechanism 50 and the optical disc 102 is prevented.

Further, the overload control mechanism can apply different load releasing forces in accordance with the direction of rotation of the unloading gear 520. Such a mechanism may be formed by a shape of the lock spring, or may be formed by a shape of the fitting portion 521a of the gear 521 which fits to the lock spring 522.

In the present embodiment, the lock spring 522 and the spring holder 523 are held at one end and the lock spring 522 has a semicircular shape. In such a structure, the load releasing force is larger when the rotation is in the direction indicated by arrow d′ shown in FIG. 17 than when the rotation is in the opposite direction. In order to obtain the load releasing force which varies in accordance with the rotation direction, the shape of the fitting portion 521a of the gear 521 may be altered such that convex and concave portion has a gentle curve with respect to the rotation in the disc insertion direction and has a rapid inclination with respect to the rotation in the disc ejecting direction.

With such a structure, damage to the unloading mechanism 50 and the optical disc 102 when an overload is applied to the optical disc 102 while the optical disc 102 is being ejected can be prevented.

### [Disc Drawing-Out Prevention Mechanism 80]

In the optical disc drive apparatus 10 according to the present embodiment, as described above, when the optical disc 102 is inserted into the optical disc drive apparatus 10 shown in FIG. 6 to a predetermined position and is drawn during the loading operation, the main arm boss 402 slides in a direction opposite to arrow D by the biasing force of the main arm SP 700. With such an operation, the main arm boss 403 slides in the direction indicated by arrow F along the disc holder rotation groove 222 and is located at the main arm down completion holding groove 222b to keep the main arm 400 at the position of disc inserted state even though the optical disc 102 is not inserted.

Accordingly, a general optical disc drive apparatus requires disc drawn detection means for detecting that the disc has been drawn, main arm initializing means for returning the main arm back to the disc ejecting state, and the like.

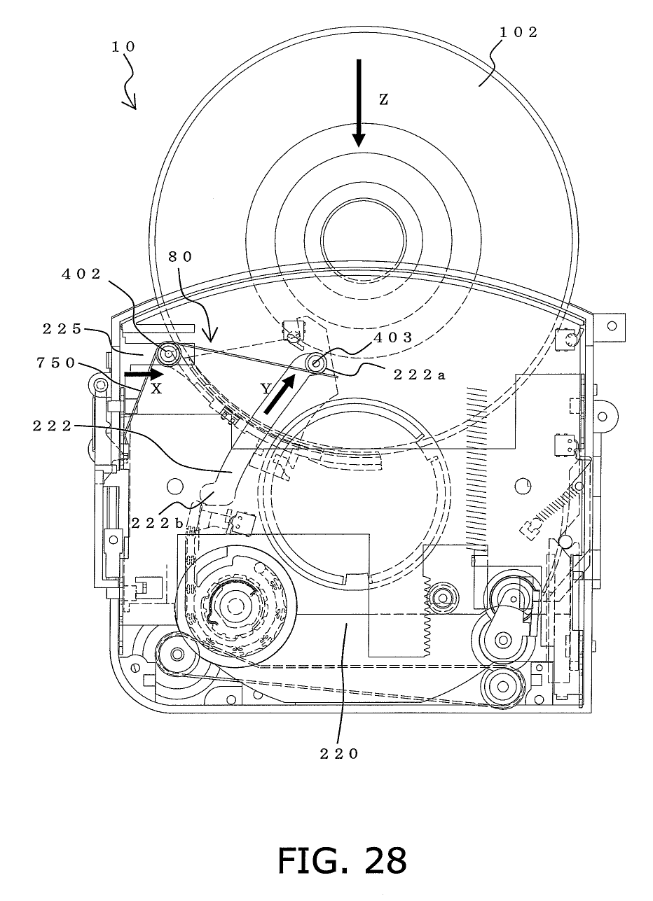

Therefore, in the optical disc drive apparatus 10 according to the present embodiment, as shown in FIG. 28, a main arm bidirectional biasing SP (third biasing member) 750 is provided. With such a member, the Disc drawing-out prevention mechanism 80 which does not require the disc drawing detection means and/or main arm initializing means can be formed.

Now, the disc drawing-out prevention mechanism 80 is described in detail.

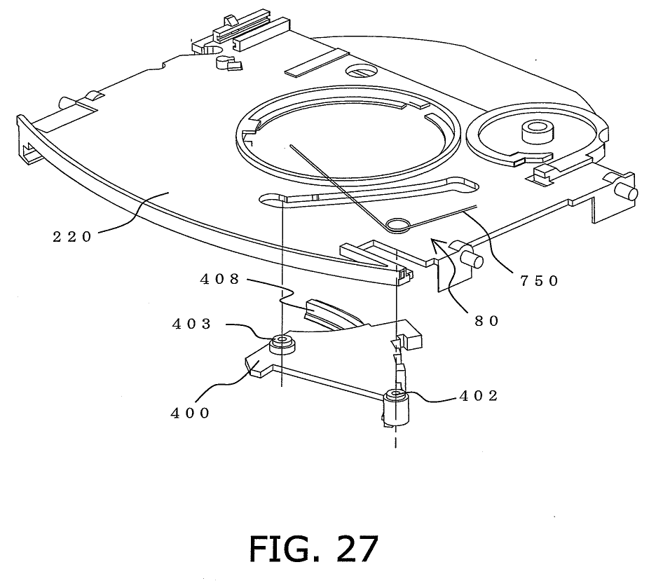

As shown in FIG. 27, the disc drawing-out prevention mechanism 80 is formed of the disc holder 220, the main arm 400, and the main arm bi-directional biasing SP 750.

The main arm boss 402 and the main arm boss 403 of the main arm 400 are preferably located within a distance shorter than the radius of the optical disc 102.

Further, in the case where the main arm boss 402 and the main arm bi-direction biasing SP 750 are set, the distance of the main arm bi-direction biasing SP 750 to one abutting end of the main arm boss 403 becomes longer than the distance to the other abutting end.

In other words, the biasing force for biasing the main arm boss 402 (the second biasing force) is larger than the biasing force for biasing the main arm boss 403 (the first biasing force).

The main arm bi-direction biasing SP 750 is attached so as to rotate the main arm 400 using the main arm boss 402 as the fulcrum in accordance with the insertion position of the optical disc 102. Further, as shown in FIG. 28, the main arm bi-direction biasing SP 750 is held by the main arm boss 402 and is a biasing spring for biasing in two directions. One end of the main arm bi-direction biasing SP 750 abuts the external frame 100 and biases the main arm boss 402 in the direction indicated by arrow X, and the other end abuts the main arm boss 403 to bias in the direction indicated by arrow Y.

### <Description of Operations>

Hereinafter, the operations of the disc drawing-out prevention mechanism 80 when the user draws the optical disc 102 out during the disc loading operation are described in detail.

As shown in FIG. 28, before the disc is inserted, in the disc drawing-out prevention mechanism 80, the main arm boss 402 is biased in the direction indicated by arrow X by the main arm bi-direction biasing SP 750. On the other hand, the main arm boss 403 is located on the main arm up completed holding groove 222a by the biasing force of the main arm bi-direction biasing SP 750 in the direction indicated by arrow Y, and the disc ejecting state is maintained.

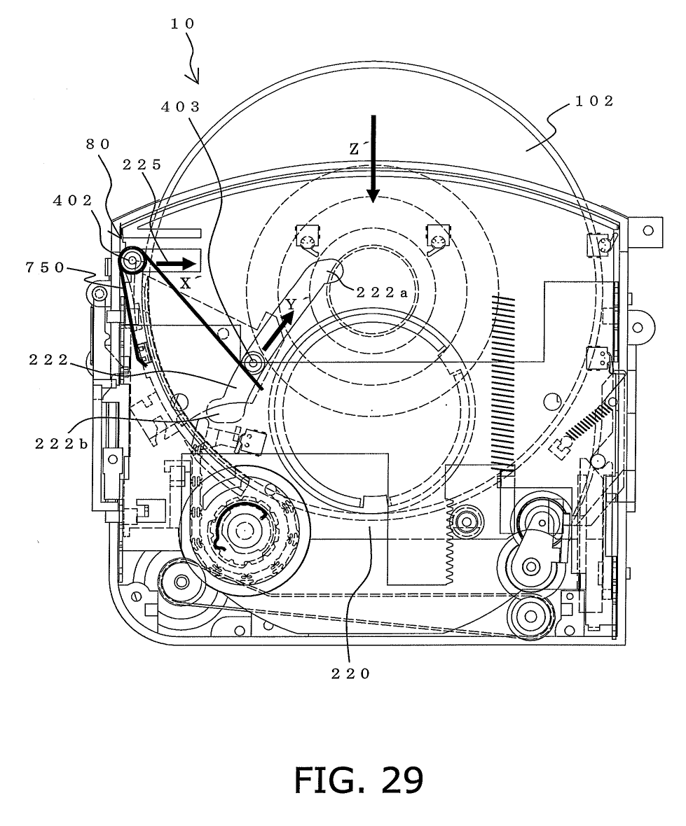

As the optical disc 102 is inserted in the direction indicated by arrow Z, the main arm 400 is spread by the optical disc 102. At this time, the main arm boss 402 slides in the direction opposite to arrow X along the disc holder control groove 225, and the main arm boss 403 slides in the direction opposite to arrow Y along the disc holder rotation groove 222 to achieve the state as shown in FIG. 29.

The biasing force in the direction indicated by arrow X′ by the main arm bi-direction biasing SP 750 at this time becomes large as the main arm boss 402 slides in the direction opposite to the direction indicated by arrow X′. Also, the biasing force in the direction indicated by arrow Y′ by the main arm bi-direction biasing SP 750 at this time becomes large as the main arm boss 403 slides in the direction opposite to the direction indicated by arrow Y′.

When the optical disc 102 is inserted in the direction indicated by arrow Z′ and the maximum radial position of the optical disc 102 is inserted to the position inner than the position of the main arm boss 402, the main arm boss 402 slides in the direction indicated by arrow X′ by the biasing force of the main arm bi-direction biasing SP 750 in the direction indicated by arrow X′. In this way, the optical disc 102 can be pushed into the optical disc drive apparatus 10.

With such an operation, the main arm 400 further rotates with the main arm boss 402 being the fulcrum. The main arm boss 403 slides in the direction opposite to the direction indicated by arrow Y′ as the optical disc 102 is pushed into the optical disc drive apparatus 10.

The biasing force in the direction indicated by arrow X′ by the main arm bi-direction biasing SP 750 at this time becomes small as the main arm boss 402 slides in the direction opposite to the direction indicated by arrow X′. The biasing force in the direction indicated by arrow Y′ by the main arm bi-direction biasing SP 750 does not change since the main arm boss 402 slides in the direction indicated by arrow X′.

If the optical disc 102 is drawn out while the optical disc 102 is being pushed into the optical disc drive apparatus 10, the biasing force of the main arm bi-direction biasing SP 750 in the direction indicated by arrow X′ causes the main arm boss 402 to spread to the outer peripheral end surface of the optical disc 102 and slides in the direction opposite to the direction indicated by arrow X′. Thus, biasing force of the main arm bi-direction biasing SP 750 in the direction indicated by arrow X′ becomes large, and the main arm boss 403 slides in the direction indicated by arrow Y′.

As the maximum radial position of the optical disc 102 is ejected outside the position of the main arm boss 402, the main arm boss 402 slides in the direction indicated by arrow X′ by the biasing force of the main arm bi-direction biasing SP 750 in the direction indicated by arrow X′. The main arm boss 403 slides in the direction indicated by arrow Y′ by the biasing force of the main arm bi-direction biasing SP 750 in the direction indicated by arrow Y′ to be located at the main arm up completed holding groove 222a.

With such an operation, the main arm 400 can be shifted to the disc ejecting state when the optical disc 102 is drawn out during the loading operation without the disc drawing-out detection means and/or main arm initializing means.

### Other Embodiments

An embodiment of the present invention has been described above. However, the present invention is not limited to the above embodiment. Various modifications may be made within the scope of the gist of the invention.

### (A)

In the above embodiment, the disc contact portion 612 contacts the optical disc 102 via the elongated contact surface in the disc jumping-out prevention mechanism 60. However, the present invention is not limited to such an example.

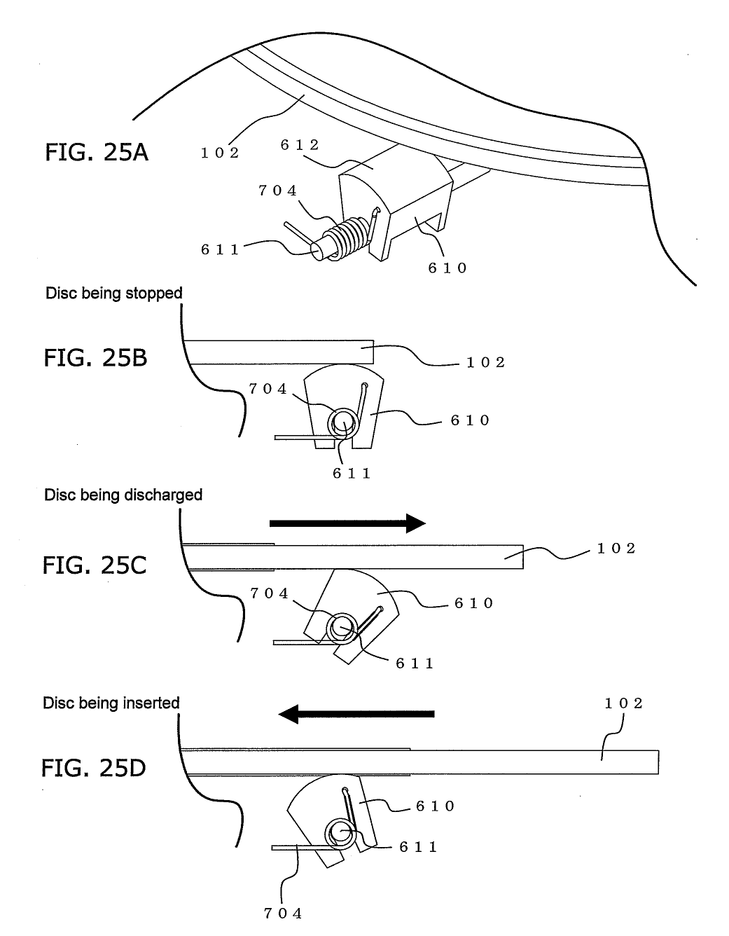

For example, as shown in FIGS. 25A through 25D, the optical disc 102 may be prevented from jumping out by using a disc braking lever 610 having a different shape.

The disc braking lever 610 is supported at the rotational shaft 611 so as to rotate in the disc insertion and ejecting direction in substantially parallel to the longitudinal direction of the disc insertion opening 101 (not shown). The disc braking lever 610 is fixed to the external frame 100 (not shown) side on the inside of the disc drive apparatus around the right and left ends of the disc insertion opening 101.

The disc braking lever 610 may be attached to one of the upper and lower sides with respect to the surface of the optical disc 102 or may be attached to both the upper and lower sides.

The disc braking lever 610 abuts the surface of the optical disc 102 and rotates in the insertion and ejecting operation direction as the optical disc 102 moves. To the disc braking lever 610, a spring for biasing (the disc biasing SP 704) is attached, and the disc braking lever 610 is biased such that the rotational position returns when it no longer abuts the optical disc 102.

Further, the disc braking lever 610 can rotate in the substantially vertical direction with respect to the disc insertion direction.

The disc contact portion 612 which contacts the optical disc 102 has a shape having a semi-circular cross section. The disc contact portion 612 is also formed to have a predetermined inclination with respect to the longitudinal direction of the disc insertion opening 101. Such inclination is set such that the contact portion between the outer periphery of the optical disc 102 and the disc contact portion 612 varies in accordance with the degree of insertion and ejecting while the optical disc 102 is being inserted and ejected. At this time, the disc contact portion 612 has an angle such that it abuts only to the outer periphery of the optical disc 102 and does not abut the recording surface. Such an inclination may be set when the disc contact portion 612, which is a part of the disc braking lever 610, is formed, or may be set by the relative positions where the disc braking lever 610 and the external frame 100 are attached.

Now, the operations of the disc jumping-out prevention mechanism 60 when the disc is being ejected is described in detail with reference to FIGS. 25A through 25D.

The positional relations between the disc braking lever 610 and the disc insertion opening 101 are same as that in the first embodiment as described above.

The disc braking lever 610 is attached so as to control an end of the disc insertion opening 101, which is a part of the width of the disc insertion opening 101. When the optical disc 102 is started to be ejected from the disc insertion opening 101, the width of the optical disc 102 which passes through the position of the disc insertion opening 101 becomes larger as it is being ejected, and the optical disc 102 contact the braking start position.

As the optical disc 102 is further ejected, as shown in FIG. 25C, the disc braking lever 610 rotates in the ejecting direction as it abuts the optical disc 102. The disc contact portion 612 serves as a braking contact portion which contacts only when the optical disc 102 moves in the ejecting direction. The contact portion between the disc contact portion 612 and the optical disc 102 slides in the direction toward the end of the disc insertion opening 101 on the disc contact portion 612. The disc contact portion 612 is inclined such that it contacts only the outer peripheral end of the optical disc 102 at this time. Thus, the disc braking lever 610 gradually rotates in the direction substantially vertical with respect to the disc ejecting direction.

When the optical disc 102 is further ejected and it reaches to the position where the maximum diameter position of the optical disc 102 passes the disc insertion opening 101, the contact portion between the optical disc 102 and the disc contact portion 612 slides to the braking middle position where is most remote from the braking start position on the disc contact portion 612.

When the optical disc 102 is further ejected, the contact portion between the optical disc 102 and the disc contact portion 612 slides from the braking middle position to the braking start position on the disc contact portion 612.

When the disc unloading operation is finished and the operation for ejecting the optical disc 102 is completed, the optical disc 102 and the disc braking lever 610 abut each other. Thus, the disc braking lever 610 can also serves as a retaining mechanism for preventing the optical disc 102 from falling down from the disc insertion opening 101.

On the other hand, for inserting the optical disc 102, as shown in FIG. 25D, the width of the optical disc 102 passing through the disc insertion opening 101 becomes wider as the disc is inserted, and the optical disc 102 contact the braking start position on the disc contact portion 612.

As the optical disc 102 is further inserted, the disc braking lever 610 rotates in the insertion direction since it abuts the optical disc 102. The contact portion of the disc contact portion 612 contacts only when the optical disc 102 moves in the insertion direction.

In this way, the contact position of the disc contact portion 612 is changed not only at the ejecting position when the disc is being ejected but also at the insertion position when the disc is being inserted.

Accordingly, a desired braking force can be applied at the disc insertion/ejecting position when the disc is inserted/ejected.

This allows that, for example, the braking force is set weak for inserting the disc in order to reduce resistance during insertion, and the braking force of a certain degree which can prevent the disc from jumping out is applied for ejecting.

Further, as in the above embodiment, surface finishing and/or material of the disc contact portion 612, or the biasing spring may be altered in order to adjust the braking force. Also, the shape of the disc contact portion 612 may be altered to adjust the braking force in the insertion direction and ejecting direction.

### (B)

In the above embodiment, the main arm bosses 402 and 403 are fit to the plurality of guiding grooves (disc holder rotation groove 222, the disc lever releasing groove 223, and the disc holder control groove 225) for rotating the main arm 400 along the outer periphery of the optical disc 102. However, the present invention is not limited to such an example.

For example, the main arm may be rotated by fitting of protrusions or the like instead of guiding grooves.

### (C)

In the above embodiment, the disc drive apparatus 10 records/reproduces information on/from the optical disc 102. However, the present invention is not limited to such an example.

For example, the present invention may be applied to various types of disc drive apparatus which records/reproduces information on/from other types of discs.

### INDUSTRIAL APPLICABILITY

Since the disc drive apparatus of the present invention can simplify the structure for loading discs to a turntable along a surface direction and has an effect of achieving smaller and thinner apparatus, it may be widely applicable to the various types of the disc apparatuses which record/reproduce information on/from various types of discs.

What is claimed is:

1. A disc drive apparatus, comprising:
a frame portion having an insertion opening to which a disc of a circular shape is to be inserted;
an abutting portion which is located near one end in a longitudinal direction of the insertion opening and which abuts an end of the disc inserted from the insertion opening;
a turntable which holds the disc in a rotatable manner; and
a single arm member which guides the disc to a position above the turntable or from the turntable in an ejecting direction while it pinches the disc with the abutting portion and moves along an outer periphery of the disc.

2. The disc drive apparatus according to claim 1, further comprising:
a first biasing member which applies a biasing force for pulling one end on the insertion opening side of the arm member.

3. The disc drive apparatus according to claim 1, further comprising:
a disc holder which moves in an insertion direction of the disc as the disc is inserted or ejected and which includes a first groove formed from near the insertion opening along the insertion direction and a second groove formed in a substantially vertical direction with respect to the insertion direction, wherein:
the arm member includes a plurality of boss portions which move within the first and second grooves while they remain fitted into the first and second grooves.

4. The disc drive apparatus according to claim 3, further comprising:
a holder portion, which includes a pair of side surface portions along a direction substantially perpendicular to the surface of the disc on right and left sides and a pair of third grooves, which are formed on the pair of the side surface portions on the right and left sides and have step portions in the substantially vertical direction, and which slides in the disc insertion direction, wherein:
the disc holder includes ribs which protrude along a direction orthogonal to the insertion direction in the surface direction of the disc and which move along the third grooves while they remain fitted into the third grooves.

5. The disc drive apparatus according to claim 3, further comprising:
a lock mechanism which retains the position of the disc holder so as to be flush with the insertion opening until the disc is shifted to the clamped state where it is set on the turntable.

6. The disc drive apparatus according to claim 1, further comprising:
a retraction mechanism which retracts the arm member outside in a radial direction of the disc once the disc is shifted to the clamped state.

7. The disc drive apparatus according to claim 1, further comprising:
an ejecting mechanism which drives the arm member such that the disc moves from the position on the turntable to the position where a diameter portion of the disc passes between an end on the insertion opening side of the arm member and the abutting portion.

8. The disc drive apparatus according to claim 1, further comprising:
a braking portion which applies a braking force for controlling movement of the disc in the surface direction of the disc when the disc is being inserted/ejected.

9. The disc drive apparatus according to claim 8, wherein:
the braking portion abuts only to an outer peripheral edge of the disc and applies a braking force to the disc.

10. The disc drive apparatus according to claim 8, wherein:
the braking portion alters a magnitude of the braking force by moving the position where it abuts the disc as the disc is being inserted/ejected.

11. The disc drive apparatus according to claim 8, wherein:
the braking portion includes a second biasing member which rotates while abutting a part of the disc and applies a biasing force in the rotational direction.

12. The disc drive apparatus according to claim 10, wherein:
the braking portion alters an area of an abutting part, where it abuts the part of the disc, in accordance with the position of the disc.

13. The disc drive apparatus according to claim 10, wherein:
the braking portion includes a plurality of areas which have different friction resistances in the abutting portion with the disc.

14. The disc drive apparatus according to claim 10, wherein:
the braking portion includes areas treated with different surface finishing in the abutting portion with the disc.

15. The disc drive apparatus according to claim 7, wherein
the ejecting mechanism includes a driving portion and a gear configured to transmit a driving force from the driving portion,
further comprising:
an overload control mechanism which prevents damage to the ejecting mechanism and the disc when a load of a predetermined torque or greater is applied to the gear.

16. The disc drive apparatus according to claim 15, wherein:
the overload control mechanism includes an elastic portion configured to control a load to be applied to the gear and an engagement portion which engages one end of the elastic portion and releases engagement with the elastic portion when a load of predetermined magnitude or greater is applied to the gear.

17. The disc drive apparatus according to claim 16, wherein:
the overload control mechanism has only one end of the elastic portion being fixed and releases engagement between the elastic portion and the engagement portion by loads of different magnitudes in accordance with a direction of rotation of the gear.

18. The disc drive apparatus according to claim 16, wherein:
the overload control mechanism has the engagement portion of different shapes in the direction of the rotation of the gear and releases engagement between the elastic portion and the engagement portion by loads of different magnitudes in accordance with the direction of rotation of the gear.

19. The disc drive apparatus according to claim 1, further comprising:
a third biasing member which applies a first biasing force, which biases a first end on the insertion opening side of the arm member in a direction orthogonal to the disc insertion direction on the disc surface, and a second biasing force, which biases a second end opposite to the first end of the arm member in a direction of ejecting the disc, to the arm member.

20. The disc drive apparatus according to claim 19, wherein:
the third biasing member applies the second biasing force which is greater than the first biasing force to the arm member.
